(19) United States
(12) Patent Application Publication
(10) Pub. No.: US 2024/0089413 A1
(43) Pub. Date: Mar. 14, 2024

(54) SYSTEM AND METHOD FOR REMOTE OBSERVATION IN A NON-NETWORKED PRODUCTION FACILITY

(71) Applicant: Apprentice FS, Inc., Jersey City, NJ (US)

(72) Inventors: Frank Maggiore, Jersey City, NJ (US); Angelo Stracquatanio, Jersey City, NJ (US); Gary Pignata, Jersey City, NJ (US); Dani Dufee, Jersey City, NJ (US); Adam Cormack, Jersey City, NJ (US); John Zimmerman, Jersey City, NJ (US)

(21) Appl. No.: 18/512,414

(22) Filed: Nov. 17, 2023

Related U.S. Application Data
(63) Continuation-in-part of application No. 17/970,955, filed on Oct. 21, 2022.
Application No. 17/970,955 is a continuation of application No. 17/378,296, filed on Jul. 16, 2021, now Pat. No. 11,516,438.
Application No. 17/378,296 is a continuation-in-part of application No. 18/120,284, filed on Mar. 10, 2023.
Application No. 18/120,284 is a continuation-in-part of application No. 18/120,292, filed on Mar. 10, 2023.
(60) Provisional application No. 63/426,462, filed on Nov. 18, 2022.
(60) Provisional application No. 63/426,484, filed on Nov. 18, 2022.
(60) Provisional application No. 63/052,913, filed on Jul. 16, 2020.
(60) Provisional application No. 63/318,912, filed on Mar. 11, 2022.
(60) Provisional application No. 63/347,339, filed on May 31, 2022.
(60) Provisional application No. 63/426,471, filed on Nov. 18, 2022.
(60) Provisional application No. 63/318,912, filed on Mar. 11, 2022.
(60) Provisional application No. 63/347,339, filed on May 31, 2022.
(60) Provisional application No. 63/426,471, filed on Nov. 18, 2022.

(51) Int. Cl. H04N 7/18; G06F 21/31; G06F 21/84; G06T 7/73; G06V 20/40; G08B 5/22; H04N 5/04; H04N 5/262; H04W 76/30

(52) U.S. Cl. CPC H04N 7/181; G06F 21/31; G06F 21/84; G06T 7/73; G06V 20/40; G08B 5/22; H04N 5/04; H04N 5/2624; H04W 76/30; G06T 2207/10016; G06T 2207/10028; G06T 2207/20132

(57) ABSTRACT

A method includes: via a user interface of a hub device, receiving a first set of user credentials associated with a first operator, the hub device connected to a set of mobile devices; accessing a first operator schedule defining a first manufacturing operation and a first observer of the first manufacturing operation, the first observer characterized by a first set of observer credentials; detecting disconnection of a first mobile device in the set of mobile devices from the hub device, the first mobile device associated with a first device ID; in response to detecting disconnection of the first mobile device from the hub device, associating the first device ID with the first operator; and serving a first video feed from the first mobile device to the first observer based on the first device ID and the first set of observer credentials.

### CROSS-REFERENCE TO RELATED APPLICATIONS

This application claims the benefit of U.S. Provisional Application No. 63/426,462, filed on 18 Nov. 2022, and 63/426,484, filed on 18 Nov. 2022, each of which is hereby incorporated in its entirety by this reference.

This application is a continuation-in-part of U.S. Non-Provisional application Ser. No. 17/970,955, filed on 21 Oct. 2022, which is a continuation of U.S. Non-Provisional application Ser. No. 17/378,296, filed on 16 Jul. 2021, which claims the benefit of U.S. Provisional Application No. 63/052,913, filed on 16 Jul. 2020, each which is incorporated in its entirety by this reference.

This application is a continuation-in-part of U.S. Non-Provisional application Ser. No. 18/120,284, filed on 10 Mar. 2023, and Ser. No. 18/120,292, filed on 10 Mar. 2023, each of which claims the benefit of U.S. Provisional Application No. 63/318,912, filed on 11 Mar. 2022, 63/347,339, filed on 31 May 2022, and 63/426,471, filed on 18 Nov. 2022, each of which is hereby incorporated in its entirety by this reference.

This application is related to U.S. Non-Provisional application Ser. No. 17/719,120, filed on 12 Apr. 2022, and Ser. No. 17/968,684, filed on 18 Oct. 2022, each of which is hereby incorporated in its entirety by this reference.

### TECHNICAL FIELD

This invention relates generally to the field of process observation for regulated industries and more specifically to a new and useful system and method for remote observation of a non-networked production facility in the field of process observation for regulated industries.

### BRIEF DESCRIPTION OF THE FIGURES

FIG. 1 is a flowchart representation of a method;

FIG. 2 is a flowchart representation of the method;

FIG. 3 is a schematic representation of a system;

FIG. 4 is a schematic representation of the system;

FIG. 5 is a flowchart representation of the method;

FIG. 6 is a flowchart representation of the method;

FIG. 7 is a flowchart representation of the method;

FIG. 8 is a flowchart representation of the method;

FIG. 9 is a flowchart representation of the method;

FIG. 10 is a flowchart representation of the method;

FIG. 11 is a flowchart representation of the method; and

FIG. 12 is a flowchart representation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

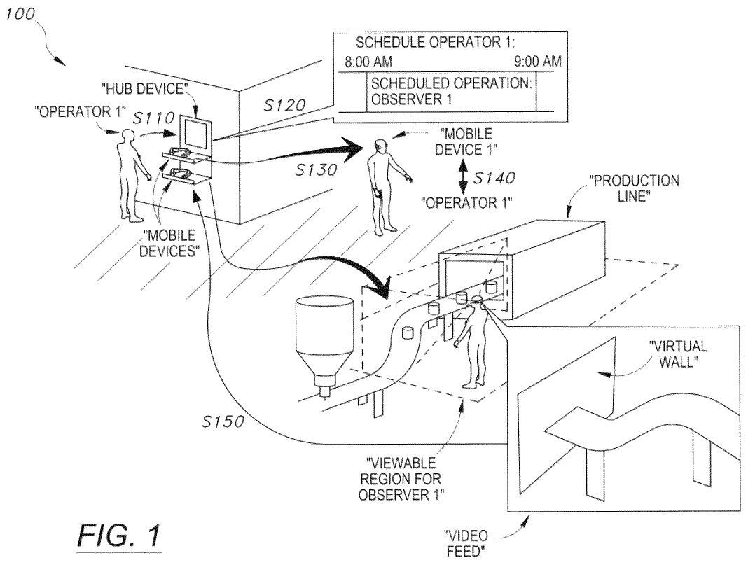

As shown in FIG. 1, a method S100 for remotely observing a manufacturing operation on a production facility including: via a user interface of a hub device, receiving a first set of user credentials associated with a first operator, the hub device connected to a set of mobile devices in Block S110; accessing a first operator schedule defining a first scheduled manufacturing operation and a first observer of the first scheduled manufacturing operation, the first observer characterized by a first set of observer credentials in Block S120; detecting disconnection of a first mobile device in the set of mobile devices from the hub device, the first mobile device associated with a first device ID in Block S130; in response to detecting disconnection of the first mobile device from the hub device, associating the first device ID with the first operator in Block S140; and routing a first video feed from the first mobile device to the first observer based on the first device ID and the first set of observer credentials in Block S150.

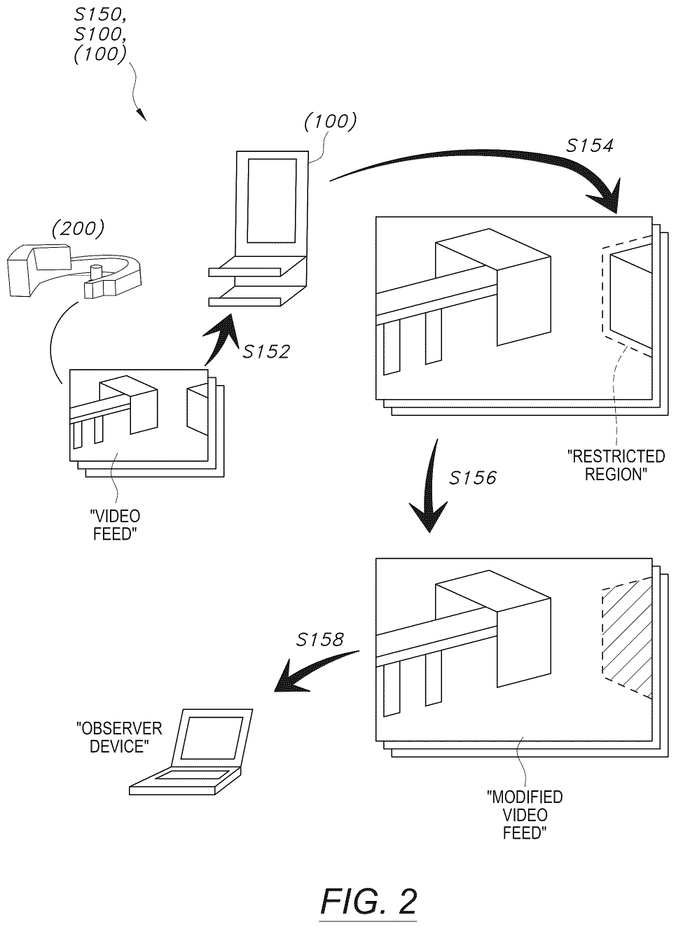

As shown in FIG. 2, the method S100 can also include: receiving the first video feed from the first mobile device in Block S152; identifying a first set of restricted regions depicted in the first video feed in Block S154; obscuring the first set of restricted regions in the first video feed to generate a first modified video feed in Block S156; and transmitting the first video feed to the first observer in Block S158.

### 2. Applications

Generally, a system includes a hub device, installed near an entrance of a production facility (e.g., a good manufacturing practice, hereinafter GMP, facility such as a pharmaceutical production facility or a biotechnical production facility), which operates as a base station for a set of mobile devices (e.g., augmented reality headsets, smartphones, tablet computers) in order to store and/or charge these mobile devices while not deployed within the production facility. The computer system executes Blocks of the method S100 to: automatically assign a particular mobile device to an operator upon deployment of the particular mobile device by the operator; detect scheduled tasks for the operator within the production facility; and coordinate a tethering session between the operator and a remote observer by routing a video feed from the particular mobile device to a remote observer. The computer system can also execute Blocks of the method S100 to: access observer credentials of the remote observer prior to routing the video feed; and, while routing the video feed to the remote observer, obscure areas of the video feed depicting regions of the production facility that are confidential based on these observer credentials.

Accordingly, the hub device can orchestrate the views that the remote observer is able to observe in live video feeds of the remote session such that the remote observer can observe only processes for which he or she is credentialed. Thus, the computer system facilitates secure, remote review and guidance of operators performing tasks within a GMP production facility—such as a contract manufacturing organization (hereinafter, “CMO”)—by production supervisors, clients of the production facility, or regulators of the production facility, thereby reducing the number of people that must be present within the production facility for tandem operation of production lines within the production facility or review of manufacturing practices within the production facility.

For example, according to manufacturing in a GMP process, an operator can work in tandem with a supervisor or quality assurance personnel, who can observe and subsequently validate each step of a task performed by the operator. However, this practice can require both the operator and the observer to be present within the production facility at the same time. In this example application, the computer system can initiate a tethering session to connect a remote observer to a point-of-view (hereinafter, “POV”) video feed from a mobile device of the operator to enable the observer to serve as a second-person verifier to observe the task performed by the operator as part of the GMP process within the production facility. The observer can then update batch records, SOPs, or procedures to indicate successful execution of the task. Additionally or alternatively, the computer system can route, to the remote observer, the live video feed and/or recordings of the task event from multiple camera views within the region in which the operator is working and/or any linked sensor data to the process to assist in the verification process. Furthermore, by detecting deployment of mobile devices and automatically assigning mobile devices to operators via the hub device, the computer system can reduce the setup time of these tethering sessions and ensure that the video feed of the correct mobile device (i.e., the mobile device corresponding to a target operator) and/or the video feeds of other cameras viewing the task being performed by the target operator are routed to the observer.

In one example application, the computer system can schedule tasks within the facility. For example, the computer system can assign batch records, procedures, operations, and tasks to specific operators within the facility and, in response to the operator logging on to a mobile device, send these batch records, procedures, operations, and tasks to the mobile device. The computer system can also configure the mobile devices to alert an operator to execute a critical path of manufacturing operations based on the concurrent batch records, procedures, and/or steps. Additionally, the computer system can assign manufacturing operations to an operator in the facility in possession of a mobile device by: monitoring and tracking the location of the mobile device to detect whether the operator is in close physical proximity (e.g., within a threshold distance) to a manufacturing operation in the critical path and, in response to detecting that the mobile device is in close physical proximity to a manufacturing operation in the critical path, the computer system can assigns that task to the mobile device to complete. Additionally, the computer system can assign equipment (e.g., to reserve for specific operations), raw materials, consumables, or other materials to operators for use in tasks assigned to these operators. The computer system can display a linked inventory system at the hub device and can add materials into this inventory by scanning these materials via an image sensor or camera of the hub device or via the mobile device. The operator can request or order these materials from the inventory and assign these materials to scheduled tasks for the operator.

In another example application, the computer system can initiate a tethering session with a representative of a client of the production facility (e.g., a client of a CMO) to enable the client to review the manufacturing practices for a production line without being physically present at the production facility. However, routing a POV video feed from the mobile device of the operator can unintentionally expose confidential information, to which the client does not include access (e.g., visual feeds of adjacent production lines, monitors displaying confidential data). Therefore, the computer system can: identify a viewable region based on the credentials of the observer; detect the location and orientation of the mobile device of an operator; and augment the POV video feed from the mobile device to obscure areas of the production facility outside of a viewable region assigned to the observer. By obscuring certain areas or regions of the facility deemed confidential the computer system can partially and selectively block, within standard video feeds, 360-degree camera video feeds, thermal camera video feeds, a haptic display, depth scanning video feeds, virtual reality video feeds, mixed reality video feeds, augmented reality video feeds, holographic display feeds, or any other sensor or feed accessible and/or viewable to the observer. Thus, the computer system can route a video feed that enables clients to review the manufacturing practices pertaining to their products without exposing sensitive data from other (adjacent) production lines within the production facility.

The computer system, via the hub device installed locally within the production facility, can also integrate video feeds from multiple mobile devices, and/or from a set of stationary devices, in order to provide a remote observer with a more wholistic view of the production facility. For example, the computer system can generate a multi-feed video call including video feeds from a set of stationary devices (e.g., digital closed-circuit cameras), connected to the hub device via a local wireless network, and a set of mobile devices, and route this multi-feed video call to the remote observer such that the remote observer can view multiple locations along a production line simultaneously. The computer system can include and/or exclude video feeds from the multi-feed video call based on the credentials of the remote observer in order to exclude video feeds that can depict confidential information or to obscure regions of these video feeds to prevent the remote observer from viewing confidential regions of the production facility.

In addition to enabling tethering sessions between operators at the production facility and remote observers of the production facility, the computer system can also detect the identity and status of operators at the production facility in order to direct new training content to an operator or detect an emergency event affecting an operator within the production facility. For example, upon detecting the identity of an operator at the hub device, the computer system can serve training content to the operator via a display of the hub device prior to enabling the operator to check out a mobile device from the hub device, thereby keeping the operator advised of updates to manufacturing or safety procedures. In another example, the hub device can track the location of the operator based on data from the mobile device and/or the set of stationary devices located throughout the facility and identify a status of the operator based on her movement through the facility and/or in performing a task. The computer system can then detect an extended period of inactivity or a dangerous event such as a fall, mechanical malfunction, or fire at the production line and, in response to detecting any of these events, trigger an alarm and/or direct emergency services to the location of the injured or endangered operator.

### 3. System

Generally, the computer system can include a hub device, which functions as a base station for a set of mobile devices and can communicate with a set of stationary devices (e.g., digital closed-circuit imaging devices, LIDAR devices, passive infrared devices, wireless localization beacons) arranged within a production facility. The hub device can communicate with the set of mobile devices and/or the set of stationary devices via a shortrange wireless protocol such as WIFI, ZIGBEE, BLUETOOTH, and/or BLE.

Alternatively, the computer system can maintain an airgap between the set of mobile devices and the hub device during operation of the mobile devices in order to reduce the number of attack surfaces for the production facility and prevent interception of video feeds captured by the set of mobile devices by a third party. In this variation, the computer system can lack wireless network infrastructure either for security purposes or because the wireless network has not been extended to that area of the facility. In this alternative implementation, the computer system can upload and transmit a video feed captured and/or recorded to the local memory drive of a mobile device upon detecting a direct connection (e.g., a wired or short-range wireless connection) with the mobile device after completion of a scheduled manufacturing operation.

### 3.1 Hub Device

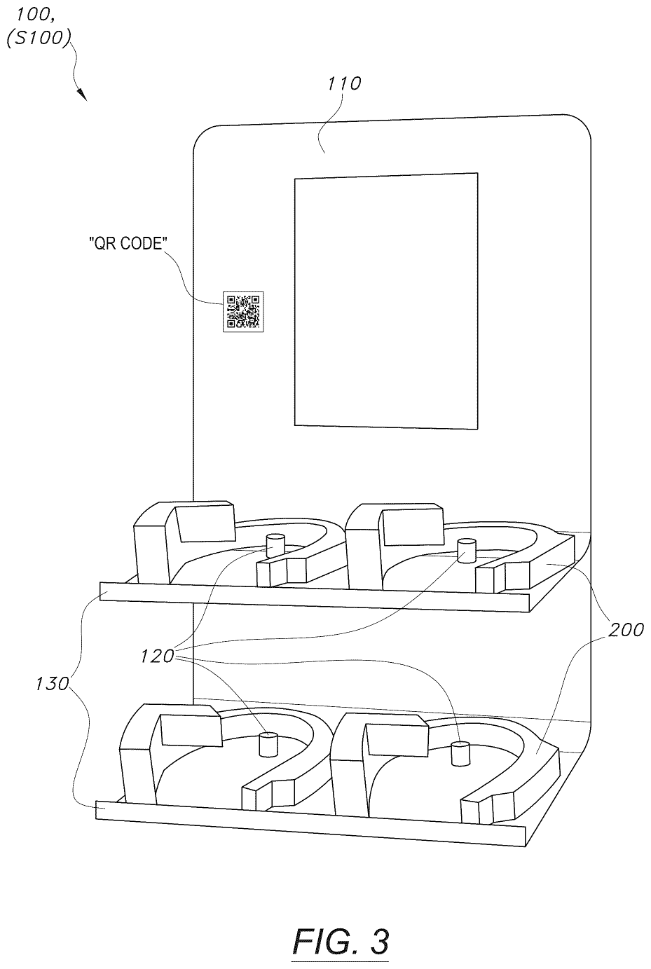

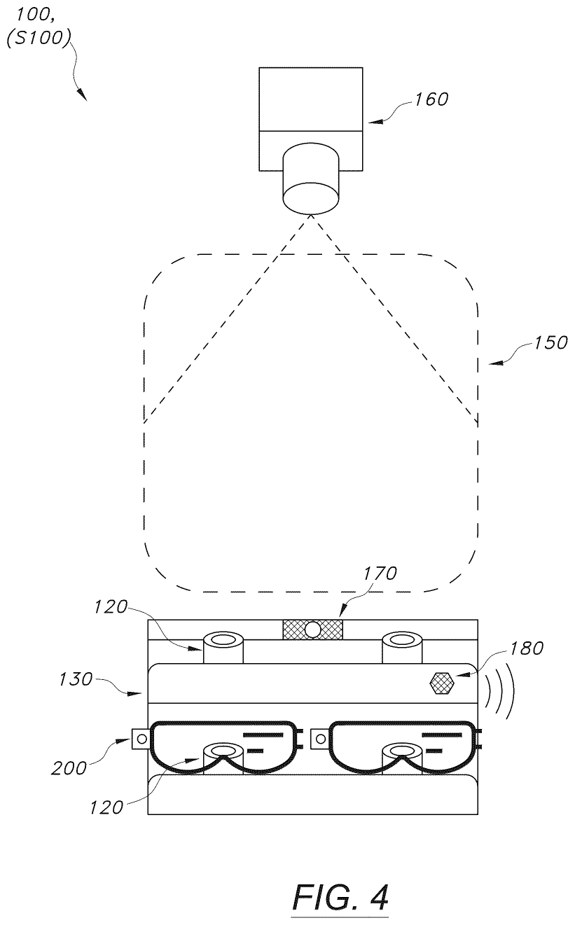

As shown in FIGS. 3 and 4, the hub device is a network-connected (i.e., local-area-network-connected, internet-connected, cellular internet connected, satellite internet connected, radio-connected, line-of-sight connected, or other multiple-input multiple-output network) charging station and router for the set of mobile devices and the set of stationary devices deployed in the production facility while also including a user interface with which users can login, logout, initiate tethering sessions, and/or receive prompts, updates, or training content pertaining to operation of the production facility. More specifically, the hub device can include a chassis housing an integrated tablet computer, speaker, microphone, digital camera, and/or a wireless router. The chassis can also include a set of shelves or charging locations on which the set of mobile devices can be stored and charged (e.g., via connection to a charging cable integrated with the hub device or via an inductive charging system integrated with the hub device). The hub device can include a set of user interfaces (e.g., touch screen, physical keyboard, speech recognition software executing on the tablet computer) such that an operator in the production facility can input data into the hub device and interact with prompts or training content displayed at the hub device. Alternatively, the computer system can include at least one user authentication input device which authenticates the identity of the operator via a biometric or non-biometric form of identification. Thus, when installed at an entrance to a production facility, the hub device acts as an easily accessible base station from which operators can check-out mobile devices for use within the production facility.

In one implementation, the hub device is configured to mount to a wall within the production facility in order to improve operators' physical and/or visual access to the hub device without occupying valuable floorspace within the production facility. Alternatively, the hub device can be configured to mount within an aseptic gowning area in order to make mobile devices available to operators during the gowning process such that the operators can place the mobile devices under personal protective equipment such as face shields. Alternatively, the hub device can be mounted to a mobile cart such that the hub device can be effectively positioned for usage by the operators

In another implementation, the hub device is configured to be water resistant (e.g., IP67 rating) and chemically resistant to facilitate frequent cleaning (such as with Spore-Klenz or other aggressive chemicals regularly used for facility decontamination) and sterilization of the hub—such as through vaporized hydrogen peroxide or another sterilization method—in order to maintain GMP within the production facility. For example, the chassis of the hub device can be manufactured from stainless steel (e.g., 316L stainless steel), medical grade plastics (e.g., polypropylene), borosilicate glass, and/or any other chemically and thermally resistant material. The hub device can also include a cover or protective shell that is removably attached to the hub unit and/or the shelves for the mobile devices to fully enclose them during the cleaning process. Alternatively, hub device can include an attached enclosure to store the mobile devices protected from any harsh cleaning chemicals or sterilization processes. Additionally, the internal enclosures can include UV lights to reduce the microbial load on the surfaces of the mobile devices stored at the hub device.

In yet another implementation, as shown in FIG. 4, the hub device can include a shelf 130 and a set of charging points 120 for charging mobile devices 200 and a projected and/or virtual display screen 150. The hub device can include a video projector 160 mounted within a housing in an alternate location with the proper Keystone effect to prevent image distortion of the projected image at the projected display screen 150. In this implementation, the computer system can generate a projected image projection mapped onto a piece of equipment or onto other areas within the facility to provide contextual information to the operators. Alternatively, the computer system can include a virtual display for an augmented reality, a virtual reality, a mixed reality, and/or a holographic device as a display device. In addition the hub device can include wireless charging stations such as via inductive charging stations or through wireless charging at a longer distance. The shelf 130 of the hub device can include additional sensors such as an integrated camera 170, a Bluetooth beacon for spatial localization, a wireless network device 180 which transmits a wireless signal to the mobile devices 200 or other hub devices 100, or other sensor devices located within the production facility.

In yet another implementation the computer system can include a primary hub device with multiple smaller hub devices distributed throughout the facility. The smaller hub devices can be connected to the primary hub device via a network connection such as an internet radio connection, a local network connection or a distributed network connection such that each hub device connects to at least one primary hub device within the facility. The smaller hub units can include sensor devices for the mobile devices within the facility and can include charging setups for those devices. The smaller hub units can additionally include input devices, such as a keyboard for entering in data, cameras, and an authentication input device for authentication of completed tasks within the different operating areas of the facility. The computer system can include biometric or non-biometrics means of authentication of the operator. Thus, the computer system can capture initial login credentials with which the computer system can log an operator into the mobile device, authenticate completion of a scheduled manufacturing operation by the operator, and/or verify, by a second operator, that a first operator completed a scheduled manufacturing operation. For example, the second operator can observe the first operator in real-time as they are executing a scheduled manufacturing operation to ensure that it is executed properly (e.g., by observing the technique used to complete the scheduled manufacturing operation) and subsequently authenticate, at the computer system via the input device, that the scheduled manufacturing operation is successfully executed. In another example, the second operator can review a final product produced as a result of a scheduled manufacturing operation and based on the state of the final product, authenticate that the scheduled manufacturing operation has been properly executed by the first operator. The computer system can access a series of verification or authentication steps corresponding to each scheduled manufacturing operation in order to enable proper verification of the scheduled manufacturing operation.

The hub device can include a set of charging points, each corresponding to a mobile device in the set of mobile devices. In one implementation, the hub device includes a set of shelves extending outward from the hub device, mounted to a wall, with charging cables integrated into the shelves. Thus, an operator can place a mobile device onto a shelf and insert the charging cable into the mobile device to initiate charging. In another implementation, the hub device can include a set of docking ports configured to engage directly with the mobile device such that manipulation and insertion of cables into the mobile devices is not required to initiate charging of the mobile devices. In yet another implementation, the hub device can include a set of induction charging locations within the set of shelves such that compatible mobile devices can be wirelessly charged while resting on the set of shelves of the hub device. In an additional implementation, the computer system can include storage for a set of swappable batteries for the mobile devices such that operators in the production facility can quickly replace the batteries of the mobile devices. In a further implementation, the hub device can include a set of auxiliary shelves that can expand the capacity of the hub device in order to charge additional mobile devices, batteries, accessory devices, accessory cameras, sensor devices, or to store these accessory devices to be utilized with the mobile devices and/or the hub unit.

The hub device can indicate or display the charging status (e.g., the current battery capacity) of each mobile device that is currently charging at the hub device via a display or via lighted indicators integrated with the chassis of the hub device near to each charging point of the hub device. Thus, an operator can select a mobile device for use within the production facility that is sufficiently charged. The computer system can recommend the mobile device to the operator characterized by the greatest level of charge, the mobile device characterized by specifications appropriate for or suited to the scheduled manufacturing operations assigned to the operator (e.g., a mobile device with intrinsically safe ATEX specifications for operating in a facility requiring an explosion proof device or for manufacturing operations involving flammable solvents, a mixed reality device suited for completion of a particular manufacturing operation), or the operator's personal device that has been assigned to them.

In one implementation, the hub device can include a QR code emblazoned on the chassis of the hub device. The QR code can represent information regarding the location of the hub device within the production facility and the identity of the hub device (e.g., in order to coordinate direct calls to the hub device). Thus, an operator using a mobile device can scan the QR code of the hub device to obtain additional information about the hub device. In this implementation, the mobile device can automatically localize itself within the production facility based on its proximity to the hub device upon scanning the QR code of the hub device. In another implementation in which the hub device is located at a fixed location on a facility wall, the hub device can provide a point-cloud identification of the hub device to the mobile device upon scanning the area. In alternate embodiments the hub device can contain a Bluetooth beacon, a radio transmitter, or other form of electronic identification to provide identification to the mobile device. In another implementation, the hub device can be installed on a cart or other mobile platform (e.g., a vehicle), thereby enabling operators to move the hub device toward a location of a scheduled manufacturing operation within the production facility. For example, the hub device can be installed on a wheeled cart and an operator can move the cart toward a location at which the operator plans to execute a scheduled manufacturing operation. The hub device can then more effectively observe the scheduled manufacturing operation with an integrated camera and more effectively issue prompts and/or warnings to the operator during one or more scheduled manufacturing operations.

### 3.2 Mobile Devices

Generally, the computer system can include a set of mobile devices such as a set of augmented reality headsets, each augmented reality headset including a heads-up display, eyes-up display, head-mounted display, or smart glasses configured to render augmented reality content for an operator wearing mobile device. Alternatively, the mobile device can include a Wi-Fi-enabled smartphone, tablet, or wearable camera device connected to a separate augmented reality device, such as: removably attachable to an operator's coveralls, clean room gowning, and/or personal protective equipment; carried in the operator's hand; or worn on a lanyard on the operator's neck. The mobile device can be separate or integrated into the Personal Protective Equipment (PPE) for the operator to wear within the facility. The hub device can additionally contain storage for the PPE to be used along with the mobile device, such as storing the safety glasses or goggles to be used with the mobile device in the facility for safety purposes as required. Alternatively, the mobile device can be a robotic device such as a robotic drone, a mobile robot (wheeled or legged), an articulating arm, and/or a motorized mobile device.

Furthermore, the mobile device can include: a suite of sensors configured to collect information about the mobile device's environment; local memory (and/or connectively to cloud-based memory) configured to (temporarily) store a localization map of a room; and a controller configured to determine a location of the mobile device in real space, such as based on the localization map, a hierarchy of localization methods, and data collected by the suite of sensors. For example, the mobile device can include: a depth camera paired with a 2D color camera; and/or a stereoscopic color camera. Each of these optical sensors can output a video feed containing a sequence of digital photographic images (or “frames”), such as at a rate of 20 Hz, and the controller can compile concurrent frames output by these optical sensors into a 3D point cloud or other representation of surfaces or features in the field of view of the mobile device. Following receipt of a localization map of a room occupied by the mobile device and generation of a 3D point cloud (or other representation of surfaces or features in the field of view of the mobile device), the controller can implement point-to-plane fitting or other techniques to calculate a transform that maps the 3D point cloud onto the localization map in order to determine the position of the mobile device within the workspace area. The mobile device can additionally or alternatively include a motion sensor and/or a depth sensing device, and the mobile device can generate a map of the working space area and track its location and orientation within this map based on features detected in photographic and/or depth feeds recorded by these devices. The mobile device can similarly track its location by comparing constellations of features detected in photographic and/or depth feeds recorded by these devices to a 3D map of the facility supplied by the computer system. Additionally, the mobile device can execute other localization techniques such as signal-to-noise-ratio-based beacon localization utilizing a set of wireless beacons distributed throughout the work area and production facility.

The mobile device can also: implement object detection and object recognition techniques to detect and identify equipment, materials, consumables, and or other components or objects within the workspace based on constellations of features detected in photographic and/or depth feeds recorded by these sensors; implement methods and techniques similar to those described above to localize these objects within the workspace; track the position of the mobile device relative to these objects; and detect interactions between the operator and these objects accordingly. Thus, by tracking equipment, particularly mobile equipment, the computer system can verify the completion of scheduled manufacturing operations included in a critical path and can initiate cascades of other steps based on the presence and location of the equipment, consumables, raw materials, mobile devices, and operators within the facility workspaces.

However, the mobile device can include any other type of sensor in any other quantity and can implement any other method or technique to calculate its pose within a room based on a localization map of the room and data recorded by these sensors.

In one implementation, the mobile device can include a wireless communication module (e.g., a wireless transceiver) configured to wirelessly communicate with the hub device. In this implementation, the mobile device can transmit, in real-time, a video feed captured by the camera of the mobile device to the hub device for further processing and transmittal to an observer of a scheduled manufacturing operation.

In another implementation, the mobile device does not include a wireless communication module and is not physically capable of wirelessly transmitting a video feed to the hub device. In this implementation, the mobile device can include a video cache configured to store a video feed depicting a set of scheduled manufacturing operations for upload to the hub device upon reconnection of the mobile device to the hub device (e.g., via a wired connection or near-field communication connection).

### 3.2 Mobile Autonomous Devices

Generally, the computer system can include a set of mobile autonomous devices such as drones, where the autonomous cart, equipped with a hub device as a centralized command station, coordinates the deployment and utilization of various types of drones within a manufacturing facility. The hub device acts as a control center, efficiently coordinating, charging, powering, authenticating, and providing networking resources to multiple drone types simultaneously. This integrated system allows operators to seamlessly orchestrate the actions of the drones, leveraging the capabilities of artificial intelligence systems to enhance efficiency, accuracy, and safety.

The autonomous cart serves as the hub device's physical base, incorporating power sources for charging and/or wireless charging/power beaming energy to devices at a distance away from the hub device, networking infrastructure such as WiFi, Cellular routers, modems, and other communication devices, and storage for drone deployment. Equipped with rechargeable batteries and charging stations, the cart ensures continuous power supply to the drones throughout their operations within the facility.

Operators, with the assistance of artificial intelligence systems, can control and coordinate the actions of the deployed drones through the hub device. The artificial intelligence systems can leverage data collected by the drones and sensors throughout the facility to provide real-time insights and situational awareness, enabling operators to make informed decisions and optimize drone operations. When a task arises, operators can utilize the hub device to assign appropriate drones to perform the required functions. The drones can be dispatched to specific locations or designated areas within the facility based on the nature of the task. The computer system and/or operators can input task parameters, such as payload requirements, target destinations, schedule deployments, and inspection parameters, using the hub device's user interface.

The hub device establishes and maintains a wireless network that connects all deployed drones, allowing seamless communication and data sharing among them. This network infrastructure enables real-time video feeds, sensor readings, and other data to be transmitted instantaneously between the drones and the hub device, providing operators with comprehensive information on drone operations.

Operators can interact with the hub device's user interface to monitor and control drone operations within the facility. The user interface provides a comprehensive overview of each deployed drone, its current status, location, and task progress. Operators can also communicate and collaborate with drones and other operators in real-time, enabling remote guidance, troubleshooting, and knowledge sharing. The autonomous cart system facilitates intelligent workflows, leveraging the capabilities of artificial intelligence systems and drones to create efficient and optimized operations within the facility. Operators can modify workflows on the hub device, incorporating feedback from drone operations to continuously improve processes, reduce bottlenecks, and increase overall productivity.

The autonomous cart can incorporate safety features to ensure the secure and responsible use of drones within the manufacturing facility. Safety protocols, obstacle detection and avoidance mechanisms, and emergency response procedures are integrated into both the drones and the hub device to enable operators to monitor safety parameters and intervene if circumstances require human intervention.

The autonomous cart can accommodate various types of drones, each designed for specific functions within the manufacturing facility. These drones include robotic drones, payload delivery drones, maintenance drones, security drones, environmental monitoring drones, cleaning drones, collaboration drones, and emergency response drones. Each drone type is tailored with specialized hardware and software to fulfill its designated role.

### 3.3.1 Robotic Drones

The autonomous cart can carry and deploy robotic drones that are capable of flight and precise maneuverability. The drones can be used to conduct aerial inspections of hard-to-reach areas in the facility, such as high ceilings, ventilation systems, or hazardous environments. Equipped with high-resolution cameras and sensors, these drones can provide real-time video feeds to the hub device, allowing operators to remotely monitor critical areas and perform inspections without endangering themselves.

### 3.3.2 Payload Delivery Drones

Payload delivery drones can be deployed by the autonomous cart to transport small packages or materials within the manufacturing facility. By loading these drones with the necessary items, operators can send urgent or time-sensitive materials to other areas of the facility quickly and efficiently. This streamlines intra-facility logistics and eliminates the need for manual transportation, saving time and reducing human error.

### 3.3.3 Maintenance Drones

Specialized maintenance drones can be deployed by the autonomous cart to conduct routine inspections and maintenance tasks on equipment and machinery. The drones can be equipped with cameras, sensors, and robotic arms to perform tasks such as equipment calibration, sensor checks, or lubrication. When an operator identifies a maintenance need, the autonomous cart can dispatch a maintenance drone to the specified location, capturing data and performing necessary actions under the guidance of the operator.

### 3.3.4 Security Drones

The autonomous cart can deploy security drones equipped with surveillance cameras and advanced monitoring capabilities to enhance security within the manufacturing facility. The drones can patrol designated areas, identify potential security threats, and notify security personnel through the hub device in real-time. By proactively monitoring the facility, security drones can help prevent unauthorized access, theft, or safety breaches.

### 3.3.5 Environmental Monitoring Drones

Equipping drones with specialized environmental sensors (e.g., temperature sensors) enables the collection data on various metrics, such as air quality, temperature, humidity, laser particle counters for measuring air particulates and sizing, viable air monitoring and surface contact plates for bioburden level monitoring, and other test types for monitoring throughout the manufacturing facility. By autonomously navigating the facility and mapping out sensor measurements, these drones can provide real-time environmental monitoring insights for operators to ensure optimal conditions for production processes.

### 3.3.6 Cleaning Drones

To enhance cleaning and sanitation processes, the autonomous cart can incorporate specialized cleaning drones. These drones are designed to sanitize or spray down specific areas in response to environmental monitoring, spills, and other events, effectively reducing bioburden levels and upholding cleanliness standards. Cleaning drones can be equipped with sanitization systems, such as UV-C lights or disinfectant sprayers. UV-C lights emit ultraviolet radiation that is effective in killing microorganisms, including bacteria and viruses, present on surfaces. Disinfectant sprayers, on the other hand, can release a fine mist and/or a focused pressurized spray of disinfectant substances, ensuring thorough coverage and effective sanitization. These capabilities allow the cleaning drones to efficiently sanitize targeted areas within the manufacturing facility or cleanroom spaces. The autonomous cart can interpret events of spills or contamination incidents as a trigger event, and thus deploy cleaning drones to address the issue. Equipped with sensors and vision systems, these drones can identify the spill location accurately and autonomously navigate to the site. The hub device can guide the drones to spray appropriate cleaning solutions or sanitize the affected area, effectively containing the spill and minimizing the risk of further contamination. Cleaning drones can also be integrated into scheduled cleaning routines within the manufacturing facility. The hub device can generate and manage cleaning schedules, optimizing the deployment of cleaning drones based on pre-defined intervals or specific cleanliness requirements. This proactive approach ensures a consistently clean environment while minimizing operational disruptions.

### 3.3.7 Collaboration Drones

Collaboration drones can be used by operators to communicate and collaborate remotely with colleagues in different areas of the facility. By utilizing a drone equipped with a two-way audio, images, 3D scanning, and video communication system, operators can consult or assist colleagues, provide guidance, or troubleshoot issues, all without physically being present. These drones enhance teamwork, knowledge sharing, safety, and problem-solving capabilities across the organization.

### 3.3.8 Emergency Response Drones

During emergency situations, such as fires or medical emergencies, the autonomous cart can dispatch emergency response drones equipped with specialized equipment, such as firefighting equipment or emergency medical supplies. These drones can reach affected areas quickly, provide real-time situational awareness, and even perform preliminary actions to mitigate the emergency before human responders arrive.

By incorporating various types of drones into the autonomous cart system and utilizing the hub device as a central command station, manufacturing facilities can benefit from enhanced efficiency, improved safety, and increased operational capabilities.

### 3.4 Stationary Devices

Generally, the computer system can also include a set of stationary devices such as closed-circuit digital video cameras, 360-degree cameras, LIDAR sensors, passive infrared sensors, infrared cameras, or other types of cameras or sensors installed within the production facility. More specifically, the set of stationary devices are configured to wirelessly communicate with the hub device such that the computer system can route data feeds (e.g., video feeds, lidar point clouds, infrared images) from the set of stationary devices to a remote observer via the hub device. Thus, the computer system can provide additional contextual data pertaining to a production line within the production facility during a tethering session.

In one implementation, the computer system can include a stationary device in the set of stationary devices that is a first-party device configured to interface directly with the hub device. Alternatively, the computer system can include a stationary device in the set of stationary devices that is a third-party device and is configured to communicate with the hub device via a common data format or application programming interface.

In another implementation for which the computer system is deployed to an air-gapped production facility, the set of stationary devices are connected to the hub device via a wired connection (in order to prevent remote reception of data transmitted by the set of stationary devices).

### 4. User Verification

Generally, in Block S110, the computer system can receive a set of operator credentials associated with a particular operator via the user interface of the hub device. More specifically, the computer system can receive or capture a set of operator credentials such as a username, password, email address, personal identification number, badges or key fobs, and/or biometric identifiers such as a set of fingerprint features, a set of facial features, and/or a set of retinal/iris scan features. The computer system can then compare the set of operator credentials to a set of authorized operator profiles for the production facility and, upon matching the set of operator credentials to an operator profile in the set of authorized operator profiles, the computer system can enable the operator to access the set of mobile devices stored at the hub device (e.g., by mechanically unlocking and releasing the mobile devices from the hub device or by electronically activating the mobile devices). Thus, the computer system ensures that unauthorized users cannot access the mobile devices within the production facility (through an access restricting mechanism such as a physical barrier or locking mechanism) and can identify the operator currently present at the hub device based on the physical act of receiving operator credentials via the user interface of the hub device. Alternatively, the computer system authenticates an operator who can access the device, unlocks the device from the autonomous cart and/or hub device, and logs the operator into the mobile device, then allows the operator to retrieve the wearable mobile device from the autonomous cart. The wearable mobile device can include a sensing device that can detect whether the operator is wearing the device while in the facility, such as via a capacitive sensor, a heart-rate monitor, a temperature sensor, or any other sensor type. The computer system can track the mobile device through the facility and determine the operator location within the facility, particularly the location of the mobile device during the execution of scheduled tasks to confirm the operator is the user that is performing the tasks as a form of verification within that specific area. The computer system can also receive manual verification of the completion of each scheduled manufacturing operation via an input device included in the hub device. Additionally or alternatively, the computer system can automatically identify the operator as the performer of the scheduled manufacturing operation based on the location of the operator being in close physical proximity to the location of the scheduled manufacturing operation.

### 5. Scheduled Manufacturing Operations

Generally, upon receiving a set of operator credentials, the computer system can access an operator schedule associated with the operator credentials in Block S120. The operator schedule can include a set of schedule manufacturing operations along the critical path and can indicate, for each scheduled manufacturing operation, whether the scheduled manufacturing operation is scheduled for observation by an observer in a tethering session. More specifically, the computer system can access an operator schedule defining: a first scheduled manufacturing operation; and a first observer of the first scheduled manufacturing operation, the first observer characterized by a first set of observer credentials. Thus, the computer system can link a set of observer credentials, a set of operator credentials, and any additional metadata pertaining to a scheduled manufacturing operation, in order to identify the security and/or privacy measures to apply to the video feed initiated between the operator and the observer during a tethering session between the operator and the observer.

In one example, the computer system can identify that a first operator is scheduled to perform a procedure with observation by a first observer via a tethering session. Upon identifying that an observer is scheduled to attend a tethering session, the computer system can access an observer profile corresponding to the observer and extract a set of observer credentials indicating access privileges of the observer within the production facility. Thus, the computer system can select a set of video and/or data feeds from the operator's mobile device and/or the set of stationary devices and augment the selected video and data feeds based on the access privileges of the observer.

In one implementation, the computer system can receive a selection from a hub device administrator to manually select the access privileges for the observers in the session. For example, a hub device administrator can initiate a video feed with an external vendor to help diagnose and fix an issue with a piece of equipment and quickly limit the access privileges of the external vendor immediately prior to the session. Alternatively, the computer system can schedule which devices, which cameras, which sensor data, and which equipment can be viewable for a scheduled session that is to be streamed to remote observers via the hub device. In alternate implementations, the hub device can schedule batches, procedures, operations, and tasks to specific users as a task management system. In this implementation, the computer system displays the task updates and the accompanying schedules for these tasks on the mobile devices corresponding to the operators for which the tasks were scheduled. In this implementation, the computer system can prompt operators with instructions while an operator performs scheduled manufacturing operations, which can include a single setup operation followed by a set time period for processing, such as with an automated equipment cleaning, decontamination, and/or sterilization cycle which can take minutes to setup and hours to complete the process. The computer system can prompt an operator with instructions to execute an initial setup operation and, subsequently, to complete other tasks from a different procedure while that operation is processing. The computer system can schedule some manufacturing operations earlier than others based on the timing and proximity of the tasks relative to other scheduled manufacturing operations. For example, the computer system can locate and/or track an operator as being adjacent to a mobile tank as determined by a nearby hub device monitoring the mobile device location. In this example, the computer system has scheduled a sterilization operation for the operator at the mobile tank. Upon sterilization of the mobile tank by the operator, the computer system can automatically prompt, via the hub device, the operator to complete other operations while the sterilization process is running. Alternatively, while the sterilization process is running, the hub device can adaptively schedule other critical path operations for the operator to complete from a set of manufacturing operations in a batch record. Thus, the computer system can prompt operators in the facility to efficiently complete production critical operations (i.e., manufacturing operations in the critical path) by coordinating operations, based on order, duration, and location within the facility.

### 5.1 Training Prompts

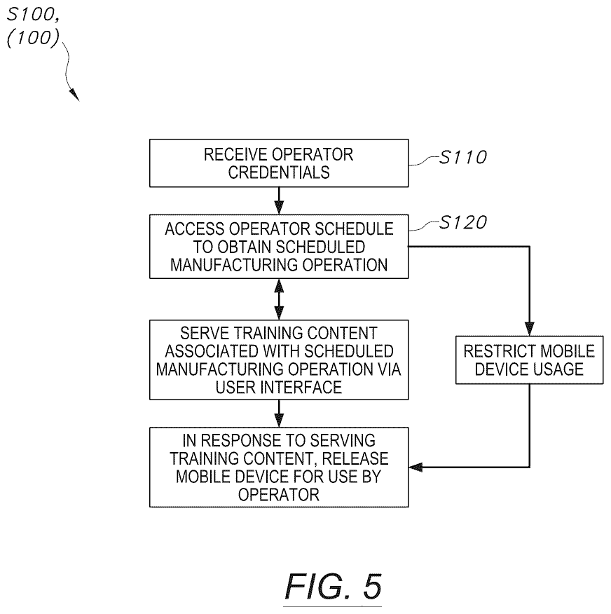

As shown in FIG. 5, upon identifying the operator and identifying any scheduled manufacturing operations for the operator, the computer system can generate training prompts or serve training content associated with the scheduled manufacturing operations to the operator directly from the hub device (e.g., via a display or touchscreen of the hub device). Additionally, the hub device can restrict usage of the mobile devices by the operator before the hub device has finished serving the training content to the operator. The computer system can serve training content to the user in the form of text displayed at the hub device, video or images displayed at the hub device, and/or audio generated at the hub device. In addition to training content, the computer system can also serve general notifications—such as broadcasted audio, text, or visual messages—or updates pertaining to the production facility such as a new set of safety precautions, the installation of a new machine on a production line, or an introduction of a new schedule for operators within the production facility. Thus, by only releasing the mobile devices for use by operators upon serving the training content to the operator via the hub device, the computer system ensures that operators review intended training content prior to beginning work within the production facility.

### 5.2 Viewable Regions and Restricted Regions

Generally, upon accessing a set of observer credentials, the computer system can identify a set of viewable regions of the production facility (e.g., a particular production line) for the observer in order to select video feeds for routing to the observer during a tethering session and/or to augment these video feeds to obscure regions of the production facility that are confidential to the observer (e.g., regions outside of this set of viewable regions). More specifically, the computer system can access a set of observer credentials including a set of viewable regions of the production facility. Alternatively, the computer system can access a set of observer credentials that includes a set of restricted regions of the production facility. Thus, the computer system can identify regions to obscure from video feeds depicting the production facility positively (e.g., via explicit identification of a restricted region) or via omission from a viewable region. Additionally, the computer system can access a set of observer credentials that explicitly identify viewable regions or restricted regions via coordinates relative to a map or other representation of the production facility. Alternatively, the observer credentials can simply specify a category or level of access of an observer.

In particular, the computer system can: categorize regions of the production facility by client, by confidentiality access level, or according to any other categorization scheme; and, upon accessing access privileges of the observer, the computer system can identify a viewable region of the facility including the regions categorized as viewable to the observer based on the access privileges of the observer. Thus, upon initiating a tethering session between an operator within the facility and a remote observer, the computer system can ensure that the observer is only capable of viewing regions of the production facility that pertain to their specific interests.

In one implementation, the computer system can also identify particular machines, displays, or data types restricted to the observer. For example, the computer system can indicate that an observer is assigned restricted access to the data displayed on the user interface of particular machines operating on a production line that is otherwise viewable by the observer. Thus, upon capturing a region of the production facility including the particular machine, the computer system can augment the video feed to obscure the user interface of the particular machine, thereby enabling the observer to view the rest of the viewable region while maintaining confidentiality of the information displayed on the particular machine.

In one implementation, the computer system can also selectively obscure personal identifying information present within the facility. Thus, the computer system can protect operators who cannot provide consent to be viewed or recorded or can subsequently submit a right-to-be-forgotten notice after their employment is terminated.

Generally, the computer system can obscure regions of any visual feed presented to an observer of a scheduled manufacturing operation and can obscure any object within a visual feed, such as a 360-degree camera video feed, a thermal display or other sensor type, a haptic display, a depth scanner display, a virtual display, an augmented display, a mixed reality display, or a holographic display.

### 6. Device Assignment

Generally, in Block S130, the computer system can detect displacement or disconnection of a particular mobile device in the set of mobile devices connected to the hub device. More specifically, the computer system can detect displacement or disconnection of a mobile device from a charging point at the hub device, where the mobile device is associated with a device identification number (hereinafter, “device ID”). In one implementation, upon connecting to the hub device via a charging cable or dock at a charging point of the hub device, the mobile device reports its device ID to the hub device. The hub device can then store this device ID in association with the charging point such that, when the mobile device is removed or displaced from the charging point the computer system can immediately identify the device ID of the device that has been displaced.

In one implementation, the computer system can detect that a mobile device has been removed or displaced from a charging point of the hub device by detecting disconnection of a charging cable from the mobile device. In implementations of the hub device including wireless charging points, the hub device can detect displacement or disconnection of a mobile device from the wireless charging point by detecting a change in capacitance and/or resistance in the charging circuit. In another implementation, the hub device can include load sensors within a shelf that supports a mobile device and can detect a reduction and/or a change in the load at the load sensor indicating that a mobile device has been removed from the shelf of the hub device. In another implementation, the hub device can include a magnetic sensor and can detect the presence of a magnet on the device and when it is removed from the shelf of the hub device. In yet another implementation, the hub device can include an integrated digital camera, which can record images of the set of mobile devices charging at the hub device and can detect, via computer vision techniques, displacement or movement of these mobile devices from charging points of the hub device.

Generally, in Block S140, upon detection of displacement of a mobile device, the computer system can assign the device ID of the displacement mobile device to an operator that has recently signed-in to the hub device. More specifically, the computer system can, in response to detecting displacement of a first mobile device from the hub device within a threshold time interval of receiving a set of operator credentials, associate the first device ID with the operator corresponding to the received set of user credentials. For example, the computer system can receive, at the hub device, a set of operator credentials for a first operator; within a threshold time interval (e.g., two minutes), the computer system can detect that a first mobile device associated with a first device ID has been displaced from the hub device; and, in response to detecting this displacement, assign the first device ID to the first operator. Thus, the computer system can leverage the physical input of operator credentials to the hub device to associate a particular operator with a particular mobile device, thereby enabling the computer system to route video and/or audio feeds to and from this mobile device for tethering sessions involving the particular operator.

In one implementation, the computer system can increase the threshold time interval for assigning a mobile device to an operator based on a duration of training content served to the operator, in response to receiving the operator credentials of the operator. For example, the computer system can, in response to serving training content of a first duration, increase the threshold time interval by the first duration.

In another implementation, the computer system can: record a video feed at the hub device (e.g., via an integrated digital camera of the hub device); execute computer vision techniques to identify the presence of an operator near to the hub device; receive operator credentials identifying the operator near the hub device; detect displacement of a mobile device concurrent with the presence of the operator near to the hub device; and assign the device ID of the mobile device to the operator based on the presence of the operator and the timing of the displacement of the mobile device from a charging point of the hub device.

Once the computer system has assigned a device ID to an operator, the operator can begin to perform manufacturing operations at the production facility while utilizing the assigned mobile device.

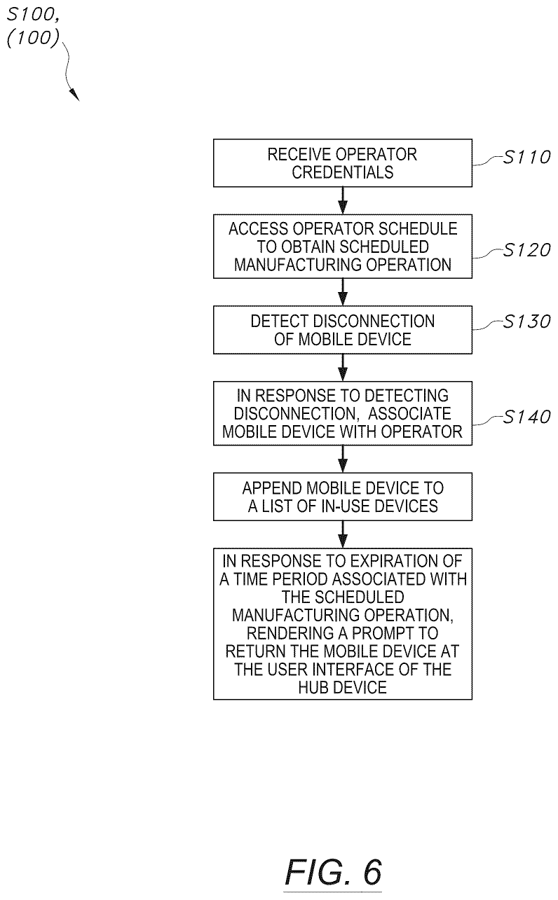

As shown in FIG. 6, the computer system can track and/or monitor the set of mobile devices deployed within the production facility and issue prompts (e.g., via the user interface of the hub device or via a prompt displayed at the mobile device) to replace mobile devices that remain deployed within the production facility outside of the duration of a scheduled manufacturing operation of an associated operator. More specifically, the computer system can: in response to detecting disconnection of the first mobile device from the hub device, append the first device ID to a list of in-use devices; in response to not detecting reconnection of the first mobile device with the hub device and in response to expiration of a time period associated with the first scheduled manufacturing operation, render a prompt to reconnect the first mobile device to the hub device at the user interface of the hub device. Alternatively, the computer system can: in response to detecting disconnection of the first mobile device from the hub device, append the first device ID to a list of in-use devices; and, in response to not detecting reconnection of the first mobile device with the hub device and in response to expiration of a time period associated with the first scheduled manufacturing operation, render a prompt to reconnect the first mobile device to the hub device at the first mobile device. Thus, the computer system can ensure prompt return of mobile devices after scheduled manufacturing operations, thereby preventing shortages of mobile devices charging at the hub device and increasing charging time for the set of mobile devices.

### 7. Tethering Session

Generally, the computer system can initiate a tethering session between the operator and assigned mobile device and a remote observer. More specifically, the computer system can route a video feed from the first mobile device to the first observer based on the first device ID and the first set of observer credentials in Block S150. In some implementations, the computer system can additionally modify the video feed to obscure regions of the manufacturing floor outside of the first viewable region. Thus, the computer system can enable POV observation of tasks performed by an operator within the production facility by a remote observer without exposing confidential regions of the production facility to a remote observer without sufficient credentials to view these confidential regions.

The computer system can initiate a tethering session automatically (e.g., at a time specified by a scheduled operation for which remote observation is prescribed) or in response to input to initiate the call by the operator or by the remote observer. For example, the operator can issue a voice command to the mobile device in order to initiate a tethering session. Alternatively, the remote observer can call in to the computer system, while specifying the operator as the recipient or by following a link provided in association with the scheduled tethering session.

### 7.1 Wireless Video Feed Routing

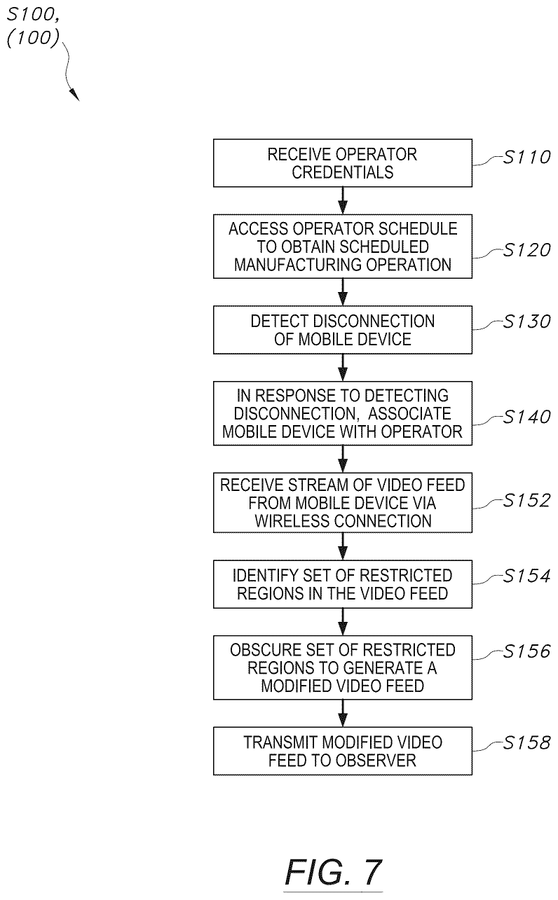

As shown in FIG. 7, the computer system can receive the first video feed from the first mobile device via a wireless connection between the first mobile device and the hub device. More specifically, the computer system can route a POV video feed from the mobile device by: recording a series of video frames at the mobile device via an integrated digital camera of the mobile device; transmitting the recorded series of video frames to the hub device via a local area network and/or via a short-range wireless protocol; and routing the series of video frames to a device of the remote observer via the internet. Thus, the mobile devices need only be connected to the local area network in the production facility in order to communicate with the hub device, thereby limiting transmission into and out of the production facility and, as a result, improving the data security of the production facility.

In this implementation, the mobile device can record and transmit the video feed to the hub device and the hub device can: localize the hub device within the production facility based on the video feed; obscure restricted regions of the production facility depicted in the video feed to generate a modified video feed; and transmit the modified video feed to the observer of the session based on a set of observer credentials. Thus, the computer system can offload the processing burden for modifying the video feed from the mobile device to the hub device, thereby improving battery life and/or processing performance of the mobile device without altering the quality of the modified video feed.

### 7.2 Air-Gapped Mobile Device Routing

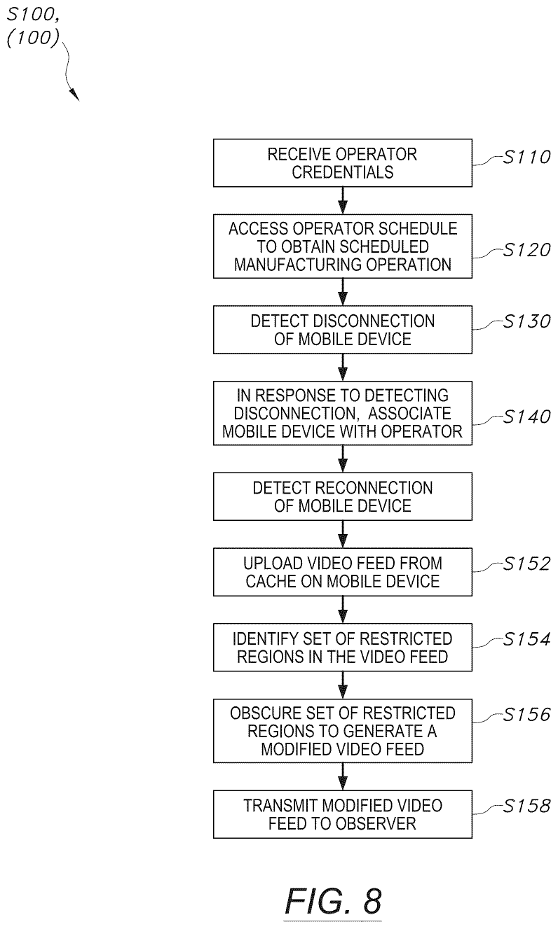

As shown in FIG. 8, in applications in which the set of mobile devices are air-gapped (i.e., not long-range wirelessly capable) during a scheduled manufacturing operation (e.g., for security purposes), the mobile device can store a video feed recorded during a scheduled manufacturing operation in a local cache on the mobile device. The hub device can then detect that the mobile device has been returned to the hub device (e.g., by detecting a wired or short-range wireless connection) and can upload the completed scheduled manufacturing operations, incomplete scheduled manufacturing operations, data/metadata associated with the completion of the scheduled manufacturing operation, and the video feed from the cache of the mobile device to the hub device before modifying the video feed and routing the video feed to an observer of the scheduled manufacturing operation depicted by the video feed. More specifically, the computer system can, in response to detecting a direct connection of the first mobile device to the hub device based on the first device ID: upload the first video feed from the first mobile device to the hub device; and transmit the first video feed from the hub device to the first observer based on the first set of observer credentials. Thus, the computer system can enable a recorded tethering session for later transmission to an observer specified by a set of observer credentials.

Additionally, the computer system can automatically identify scheduled manufacturing operations corresponding to cached video feeds based on timestamps and concurrent locations of the mobile device and a schedule of the operator of the mobile device. In one implementation, upon upload of the cached video feed to the hub device, the hub device can parse the cached video feed and crop the cached video feed into individual video segments representing each scheduled manufacturing operation completed by the operator of the mobile device. The hub device can then stream or otherwise transmit the individual video segments to observers of the schedule manufacturing operation associated with each video segment. In one example, the hub device can identify a segment of the cached video feed based the location of the mobile device in the facility relative to a location for the scheduled manufacturing operation. Alternatively, the hub device can classify frames of the video via a machine learning algorithm to identify the scheduled manufacturing operation being performed for a particular video segment in the cached video feed.

### 7.3 Location Detection and Augmented Reality

Generally, the computer system can identify the location and field of view of the mobile device based on the video feed of the mobile device and, based on this location and field of view, augment each video frame in order to obscure regions of the production facility outside of the viewable region of the remote observer. More specifically, the computer system can localize the mobile device by: detecting a proximity of the mobile device to a set of wireless beacons placed throughout the production facility and estimating the location of the mobile device via multilateration; detecting a position of an operator in a closed-circuit video feed via computer vision techniques and estimating the location of the operator via photogrammetry; calculating a point cloud of features at the mobile device and matching the detected point cloud relative to a 3D map of the production facility; and/or some combination of these processes. Thus, the computer system can: receive the first video feed from the first mobile device; identify a first set of restricted regions depicted in the first video feed; obscure the first set of restricted regions in the first video feed to generate a first modified video feed; and transmit the first video feed to the first observer.

Upon localizing the mobile device, the computer system can identify features in the video feed of the mobile device that correspond to confidential regions of the production facility. For example, the computer system can project a floorplan of the production facility indicating the viewable region corresponding to the remote observer into the video feed of the mobile device. The computer system can then identify features based on visual markers strategically placed on the equipment or area to define the boundaries, electronic beacons, or a 3D point cloud generated by the mobile device that fall outside of the viewable region. More specifically, the computer system can generate a first 3D point cloud representation of the production facility based on the first video feed; localize the first mobile device in the production facility based on the first 3D point cloud to calculate a first series of locations of the first mobile device in the production facility during the first video feed; and identify the first set of restricted regions depicted in the first video feed based on the first series of locations of the first mobile device and a field of view of the first mobile device.

Once a set of features and/or objects are identified as being outside of the viewable region of an observer of a tethering session, the computer system can augment the video feed to remove or obscure these features from the video feed. More specifically, the computer system can receive the first video feed from the first mobile device; identify a first set of restricted regions of the production facility outside of the first set of viewable regions depicted in the first video feed; obscure the first set of restricted regions to generate a first modified video feed; and transmit the first modified video feed to the first observer. In one implementation, the computer system can render a virtual wall within the video feed that blocks confidential regions of the production facility within the video feed. This virtual wall can be present in a 360-video feed blocking or obscuring the view in that specifically defined area. Alternatively, the computer system can blur (or otherwise filter) areas of the video feed that correspond to the confidential regions of the production facility, thereby rendering these areas of the video feed unintelligible to the remote observer.

In yet another implementation, the computer system can crop regions of the video feed across multiple frames of the video feed depicting restricted regions of the production facility. Alternatively, the computer system can remove frames from the video feed (while maintaining audio data for the time period occupied by the frame) that depict restricted regions of the production facility. Thus, the computer system can: receive the first video feed from the first mobile device; identify a first set of restricted regions depicted in the first video feed; crop the first video feed to remove the first set of restricted regions depicted in the video feed; and transmit the first video feed to the first observer. In this implementation, the video feed maintains frozen image frame from before the restricted area until the operator with the mobile device passes through the restricted area where the live video feed picks up once again. However, in one implementation, the computer system can include audio from the cropped period of the video feed.

In one implementation, the computer system can also combine multiple secondary (e.g., closed circuit) video feeds within the production facility in order to locate a mobile device within a production facility and subsequently modify a video feed captured by the mobile device. More specifically, the computer system can receive a secondary video feed from a second device, the secondary video feed concurrent with the first video feed and depicting the first operator and the first mobile device; localize the first mobile device in the production facility based on the first video feed and the secondary video feed to calculate a first series of locations of the first mobile device in the production facility during the first video feed; and identify the first set of restricted regions depicted in the first video feed based on the first series of locations of the first mobile device and a field of view of the first mobile device. Thus, the computer system can leverage secondary video feeds of the production facility to improve localization of the mobile device—and, therefore, the accuracy of obstructions applied to the video feed—via photogrammetry.

In another implementation, the computer system can further improve localization of a first mobile device based on a second video feed from a second mobile device also deployed to the production facility. More specifically, the computer system can: receive a second video feed from a second device, the second video feed concurrent with the first video feed and depicting the first operator and the first mobile device; localize the first mobile device in the production facility based on the first video feed and the second video feed to calculate a first series of locations of the first mobile device in the production facility during the first video feed; and identify the first set of restricted regions depicted in the first video feed based on the first series of locations of the first mobile device and a field of view of the first mobile device. Thus, the computer system can utilize all available video feeds, including those video feeds recorded by other mobile devices, to cross-reference the series of locations calculated for a mobile device, thereby improving the accuracy of any modifications made to the video feed by the hub device.

### 7.4 Multi-Operator Feed Routing

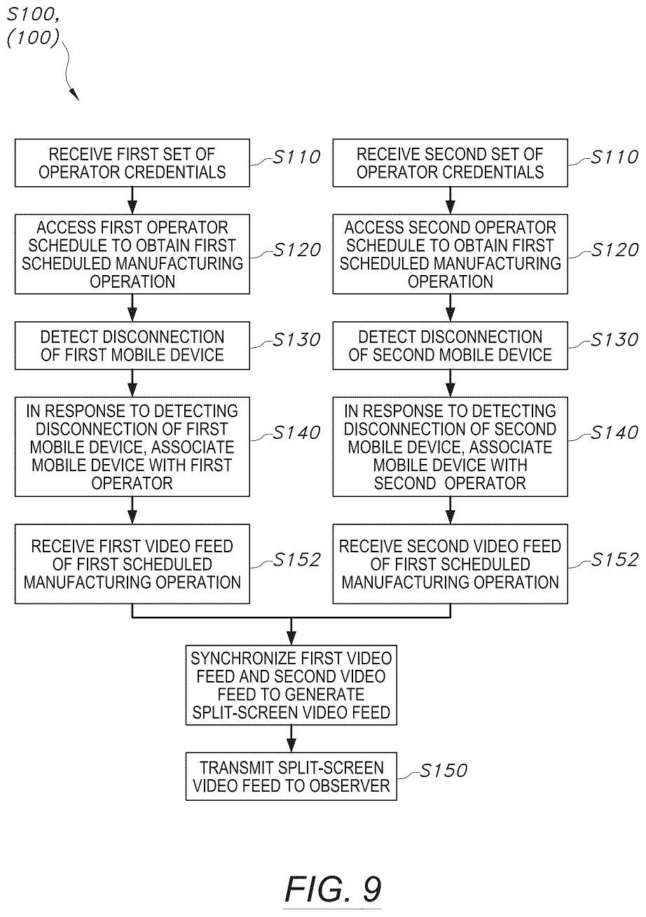

As shown in FIG. 9, the computer system can execute a multi-operator tethering session by synchronizing, compiling, and transmitting feeds from multiple mobile devices (associated with multiple operators within the production facility) to a single observer of the tethering session. More specifically, the computer system can: associate a second operator with a second mobile device and detect that the second operator shares a scheduled manufacturing operation with a first operator in the production facility. The computer system can then: receive the first video feed depicting the first scheduled manufacturing operation from the first mobile device; receive a second video feed depicting the first scheduled manufacturing operation from the second mobile device; synchronize the first video feed and the second video feed; and transmit a split-screen video feed to the first observer based on the first device ID, the second device ID, and the first set of observer credentials. Thus, the computer system can enable an observer to view a single scheduled manufacturing operation from the perspective of multiple operators.

In another implementation, the computer system can automatically detect a series of frames within a second video feed from a second mobile device of a second operator that depict the second operator performing the first scheduled manufacturing operation. The computer system can then, in real-time or upon upload to the hub device (e.g., for applications including air-gapped mobile devices), synchronize the series of frames of a second video with a first video feed depicting the first scheduled manufacturing operation. Thus, the computer system can automatically incorporate multiple video feeds into the same tethering session, even if the involvement of a second operator in the first scheduled manufacturing operation was not scheduled in advance (e.g., a second operator is called in or called over from executing another manufacturing operation to assist in the first scheduled manufacturing operation).

### 7.5 Stationary Device Video Feed Routing

In addition to routing the POV video feed from the mobile device to the device of the remote observer, the computer system can also route multiple videos and/or feeds from the set of stationary devices distributed throughout the facility to the remote observer. In one implementation, the computer system can identify a set of video feeds that include viewable regions of the production facility as candidate video feeds for the tethering session. The computer system can then: detect restricted regions depicted within these stationary video feeds and, in response to detecting a confidential region within a video feed, exclude the video feed from the tethering session. Alternatively, the computer system can generate a static video mask that occupies a portion of the video feed that depicts the confidential regions of the production facility. Thus, the computer system can identify the first set of restricted regions depicted in the secondary video feed; obscure the first set of restricted regions in the secondary video feed to generate a modified secondary video feed; and transmit the secondary video feed to the first observer.

In another alternative implementation, the computer system can generate a 3D point cloud based on features within the video feed and match the 3D point cloud to a 3D map of the production facility in order to calculate the location and field of view of the stationary device. The computer system can then detect areas within the video feed that correspond to confidential regions of the production facility and augment these areas of the video feed in order to obscure the confidential regions of the production facility.

### 7.6 Simultaneous Tethering Session Routing

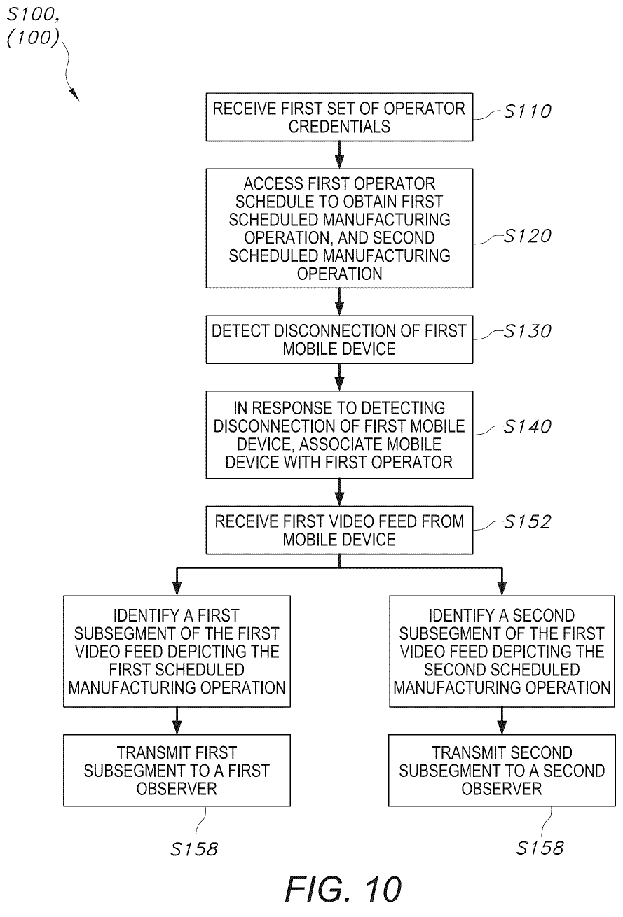

As shown in FIG. 10, the computer system can automatically distinguish between multiple scheduled manufacturing operations depicted in a single video feed from a mobile device associated with an operator within the production facility by calculating a series of locations of the mobile device during a set of scheduled manufacturing operations; and detecting a period of time for which this series of locations of the mobile device overlaps with specific regions of the production facility designated for specific scheduled manufacturing operations. The computer system can then identify specific segments of the video feed captured by the mobile device that correspond to specific scheduled manufacturing operations and route these segments of the video feed to distinct observers (which can also include distinct access privileges at the production facility).

In particular, the computer system can access the first operator schedule defining: the first scheduled manufacturing operation; a second scheduled manufacturing operation; the first observer of the first scheduled manufacturing operation; and a second observer of the second schedule manufacturing operation, the second observer characterized by a second set of observer credentials. The computer system can then receive a video feed from the first mobile device based on the first device ID; identify a first subsegment of the video feed depicting the first scheduled manufacturing operation; transmit the first subsegment of the video feed to the first observer based on the first set of observer credentials; identify a second subsegment of the video feed depicting the second scheduled manufacturing operation; and transmit the second subsegment of the video feed to the second observer based on the second set of observer credentials.

In one implementation, the subsegments of the video feed identified and routed to separate observers can be non-contiguous (e.g., if an operator is switching between multiple tasks for different clients). Thus, the computer system can cease streaming the video feed to an observer upon detecting that an operator in the tethering sessions has switched to executing a second scheduled manufacturing operation corresponding to a different tethering session.

### 8. Security and Safety Functions

Generally, the computer system can also execute security and safety functions for the production facility based on the hub device's physical position (generally in a highly accessible region of the production facility) and the hub device's function as a bottleneck for communication between the set of mobile devices and any external observers.

In one implementation, the computer system can detect a network security vulnerability, such as unauthorized access to the network, a data breach, or any networking security concern and, in response to detecting the network security vulnerability: halt the routing of the first video feed to the first observer; and store the first video feed in a local cache of the hub device. Additionally, the computer system can restrict or eliminate all communication from the hub device to a wide area network and only maintain communication with the set of mobile devices in order to continue to cache video feeds transmitted or uploaded to the hub device from the set of mobile devices.

Additionally, the hub device can include a hardware shut-off switch that, when actuated, safely disconnects the hub device from a wide area network and/or halts transmission of video feeds outside of the local area network of the production facility. Thus, the hub device can include an emergency shut-off switch configured to disconnect the hub device from an external network.

In another implementation, the computer system can also receive multiple data feeds such as temperature data, air quality data, or any other safety-related data for the production facility and, in response to the safety data indicating a safety concern, render a safety warning at the user interface of the hub device. For example, in response to detecting temperatures greater than a threshold temperature or air-quality lower than a threshold air quality within the production facility, the hub device can display and/or produce an audible alarm or warning at the user interface of the hub device, thereby indicating to operators in the production facility (who can be using air-gapped mobile devices) dangerous conditions within the production facility.

### 9. Mobile Hub Device: Autonomous Cart System

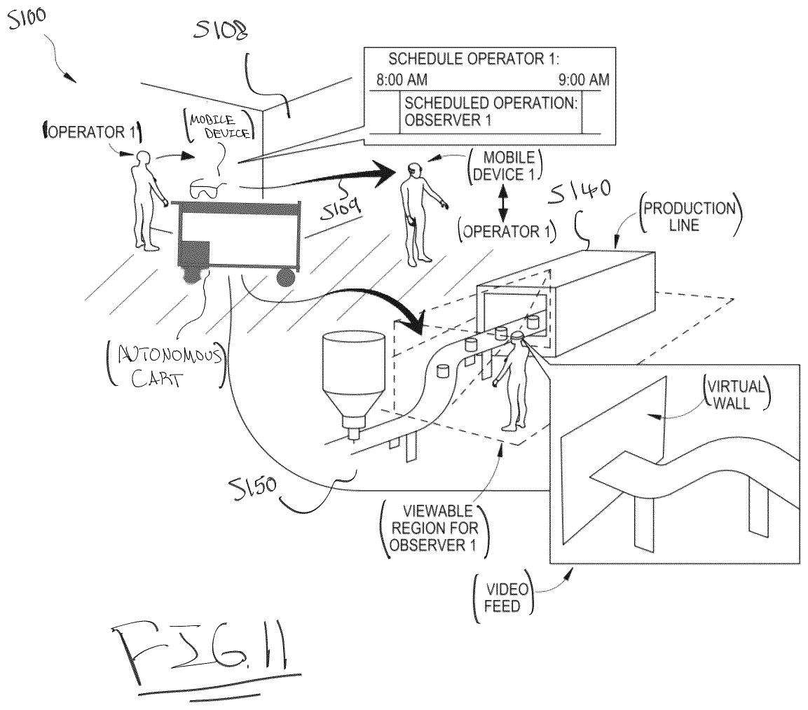

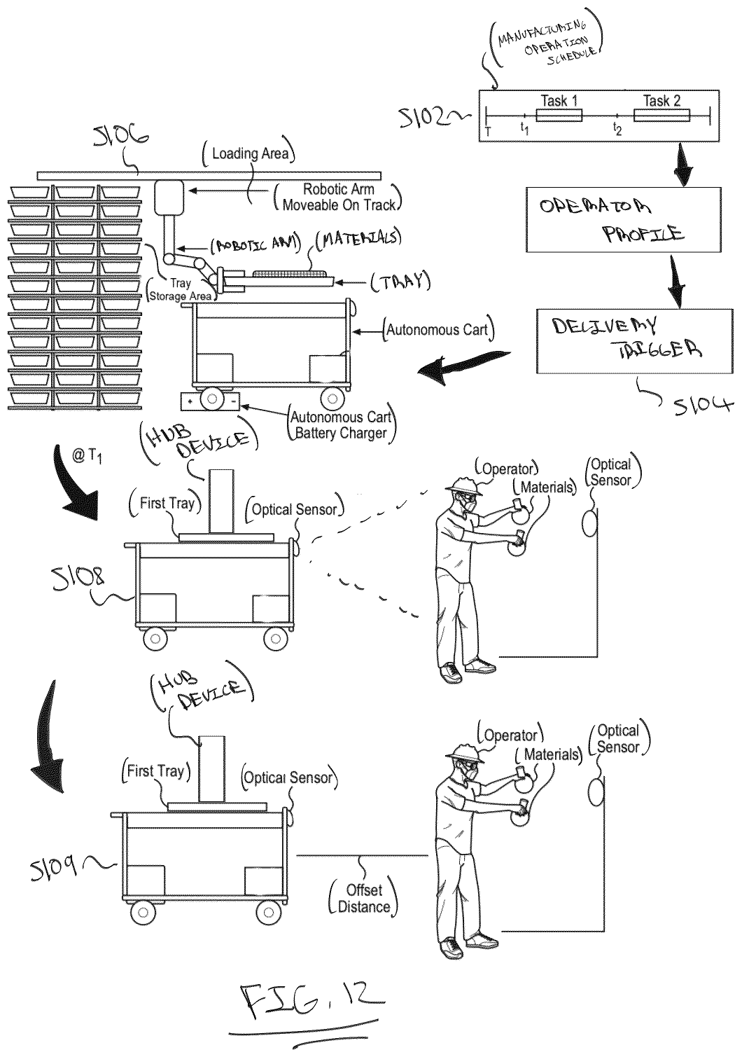

In one variation of the method S100 shown in FIGS. 11 and 12, a method for remotely observing a manufacturing operation in a facility includes: accessing a manufacturing operation schedule in Block S102 defining: a first manufacturing operation corresponding to a first operator at a target location within the facility; a first operator profile representing guidance preferences for the first operator scheduled to perform the first manufacturing operation; and a first observer profile associated with a first observer overseeing the first manufacturing operation.

The method S100 further includes: generating a delivery trigger for a set of mobile devices based on the first operator profile in Block S104; assigning the delivery trigger to a hub device connected to the set of mobile devices and arranged on an autonomous cart within the facility in Block S106; and triggering the autonomous cart to maneuver the hub device proximal the target location within the facility in Block S108.

The Method S100 also includes: in response to detecting the delivery trigger, maintaining the autonomous cart at a target offset distance from the first operator performing the first manufacturing operation at the target location in Block S109; and receiving a first set of user credentials associated with the first operator at the hub device arranged on the autonomous cart in Block S110. The autonomous cart can include an access restricting mechanism (e.g., electronic lock) to prevent unauthorized access to the mobile devices until successfully authenticated by the first operator inputting their user credentials. The access restricting mechanism can include a physical barrier between the operator and the mobile devices, such as a box, storage locker, hinged lock, cover, clamshell cover, casing, or a locking mechanism, such as a locking ring, locking cover, locking port, magnetic lock, electromagnetic lock, or other locking mechanism.

The method S100 further includes, in response to separation of the first mobile device from the hub device: associating a first mobile device, in the set of mobile devices, with the first operator according to the first set of user credentials in Block S140; and serving a first video feed from the first mobile device to a first observer portal associated with the first observer based on the first observer profile in Block S150.

### 9.1 Applications: Autonomous Mobile Kiosk

Generally, a remote computer system, a robotic loading system, and an autonomous cart can cooperate to execute Blocks of the method S100 in order to support an operator performing steps of a procedure for production of pharmacological materials within a manufacturing facility. In particular, the computer system can: access a digital procedure scheduled for performance in the manufacturing facility and defining an operator profile for performance of the digital procedure; identify a set of mobile device types configured to serve procedure descriptions and/or other supporting content to an operator during an instance of the digital procedure based on the operator profile; trigger the robotic loading system to load a mobile device including an optical sensor, in the set of mobile device types, onto an autonomous cart; and queue the autonomous cart to autonomously deliver the set of mobile devices to an operator performing the digital procedure within the facility. The autonomous cart can then: autonomously deliver the mobile devices to the operator; function as a gateway or kiosk for operator access to these mobile devices; capture a local video feed of the operator performing steps of the procedure via a camera integrated into the autonomous cart and/or integrated into a mobile device selected by the operator during a step of the procedure; and route the local video feed to a remote observer observing the operator performing the digital procedure, such as by serving the video feed to the remote operator in real-time and writing the video feed to a database for post hoc access by the remote observer.

More specifically, the computer system can access a digital procedure that contains a sequence of procedure blocks, wherein some or all of these blocks contain: a particular location within the manufacturing facility of an operator completing specified tasks; a set of materials associated with these specified tasks handled by the operator and necessary to complete these specified tasks; an operator profile defining a first degree of guidance for the operator performing the task of the digital procedure; and a target offset distance between the autonomous cart and the operator maintainable throughout completion of the specified tasks by the operator. The computer system can then: extract a set of identifiers for the set of mobile devices based on the operator profile for the operator performing the procedure and/or the type of mobile device needed to execute the procedure; assign a delivery location for the set of mobile devices; and assign a delivery trigger to the set of mobile devices based on the operator profile.

Furthermore, a robotic loading system within the facility can autonomously load the set of mobile devices—corresponding to the set of device identifiers extracted from the digital procedure—onto the autonomous cart, such as by a robotic arm retrieving the set of mobile devices, loading the set of mobile devices onto a platform of the autonomous cart, and connecting (e.g., wirelessly connecting, directly connecting) the set of mobile devices to the autonomous cart.

In one example, the autonomous cart—loaded with the set of mobile devices—can autonomously deliver the set of mobile devices to the operator within the facility at a target time based on a planned time for performance of the digital procedure. In this example, the computer system can: extract an operator profile associated with the operator performing the digital procedure; and identify a particular degree of guidance assigned to the operator performing the digital procedure in the operator profile and indicating that the operator requires observation during performance of the digital procedure. The computer system can then, in response to identifying the particular degree of guidance: identify a set of device identifiers—associated with a set of mobile devices (e.g., VR headsets, AR headsets) in a manifest of materials associated with the digital procedure based on the particular degree of guidance; assign a delivery trigger to the set of mobile devices based on a scheduled time for performance of the digital procedure (e.g., delivery trigger to deliver the set of mobile devices prior to the scheduled time); assign a delivery location for the set of mobile devices based on a scheduled location for performance of the digital procedure indicated in the digital procedure; and transmit the delivery trigger and the delivery location to the autonomous cart.

Additionally, upon loading of the set of mobile devices onto the autonomous cart, the autonomous cart can: autonomously maneuver the autonomous cart to the delivery location near the operator performing the digital procedure in response to detecting the delivery trigger (e.g., 10 minutes prior to scheduled performance of the digital procedure); access or retrieve the operator's credentials; assign a device identifier associated with a mobile device on the autonomous cart responsive to separation of the mobile device from the autonomous cart; and, in response to initiation of the digital procedure by the operator, route a video feed captured by the mobile device to a remote observer assigned to observe the operator during performance of the digital procedure.

Therefore, the autonomous cart can: maintain contextual awareness of the operator in need of mobile devices for performing digital procedures within the facility; and timely and autonomously deliver this set of mobile devices to the operator within the facility in order to route video feeds—captured by the mobile devices—to assigned observers for observing the operator performing the procedures within the facility.

### 9.2 Autonomous Cart

Generally, as described in U.S. Non-Provisional application Ser. No. 18/120,284, filed on 10 Mar. 2023, and Ser. No. 18/120,292, filed on 10 Mar. 2023, each of which is hereby incorporated in its entirety by this reference, Blocks of the method S100 can be executed by an autonomous cart to: autonomously maneuver throughout target locations in the facility; and support operators performing steps of a digital procedure within the facility, such as by delivering materials (e.g., safety materials, guidance materials) necessary for operators to perform steps of the digital procedure.

An autonomous cart can execute Blocks of the method S100 for autonomously delivering a set of materials to the operator performing steps of a manufacturing procedure within the facility. In particular the autonomous cart can define a network-enabled mobile robot that can: autonomously traverse a facility; capture live video feeds of the operator within the facility; and deliver a set of materials to the operator performing manufacturing procedures throughout the facility.

In one implementation, the autonomous cart includes: a base, a drive system (e.g., a pair of two driven wheels and two swiveling castors); a platform supported on the base and configured to transport materials (e.g., raw materials, consumables, equipment units, parts, and supplies loaded within a tray, mobile devices) associated with procedures performed within the facility; a set of mapping sensors (e.g., scanning LIDAR systems); and a geospatial position sensor (e.g., a GPS sensor). In this implementation, the autonomous cart can further include an optical sensor (e.g., visible light camera, infrared depth camera, thermal imaging camera) defining a line-of-sight for the autonomous cart and configured to capture a live video feed within line-of-sight of the autonomous cart. Additionally, the autonomous cart includes a network device configured to support a network connection to devices within the facility proximal the autonomous cart.

Furthermore, the autonomous cart includes a controller configured to access a digital procedure for the facility containing a first instructional block including a first instruction defining: a first location within the facility; a supply trigger associated with a set of materials for an operator performing the first instruction at the first location; and a target offset distance between the autonomous cart and the operator proximal the first location. The controller can then trigger the drive system to navigate the autonomous cart to a position within the facility proximal the first location defined in the first instruction of the first instructional block.

Additionally, the controller can initiate a first scan cycle and, during the first scan cycle: access a video feed from the optical sensor; extract a set of visual features from the video feed; detect a set of objects—the set of objects including the operator—based on the set of visual features; and trigger the drive system to maneuver the autonomous cart to the operator at the target offset distance to deliver the set of materials loaded on the autonomous cart to the operator. Subsequently, the controller can further initiate a second instructional block in the digital procedure in response to completion of the first instructional block.

### 9.2.1 Autonomous Cart as Mobile Kiosk

As described above—similar to the hub device—the autonomous cart can define a network-connected (i.e., local-area-network-connected, internet connected, cellular internet connected, satellite internet connected, radio-connected, line-of-sight connected, operator other multiple-input multiple-output network) charging station and router for the set of mobile devices deployed in the production facility. The autonomous cart can also include a user interface (e.g., touchscreen interface) with which users can login, logout, initiate tethering sessions, and/or receive prompts, updates, operator training content pertaining to operation of the production facility. More specifically, the autonomous cart can include a chassis housing an integrated tablet computer, speaker, microphone, digital camera, and/or a wireless router. The chassis can also include a set of shelves or charging locations on which the set of mobile devices can be stored and charged (e.g., via connection to a charging cable integrated with the autonomous cart or via an inductive charging system integrated with the autonomous cart). The autonomous cart can include a set of user interfaces (e.g., touch screen, physical keyboard, speech recognition software executing on the tablet computer) such that an operator in the production facility can input data into the autonomous cart and interact with prompts or training content displayed at the autonomous cart. Alternatively, the computer system can include at least one user authentication input device that authenticates the identity of the operator via a biometric or non-biometric form of identification. Thus, the autonomous cart can autonomously maneuver about the facility to deliver the set of mobile devices to the operator performing tasks of a digital procedure within the facility.

### 9.3. Manufacturing Operation Schedule

Blocks of the Method S100 recite accessing a manufacturing operation schedule in Block S102 defining: a first manufacturing operation corresponding to a first operator at a target location within the facility; a first operator profile representing guidance preferences for the first operator scheduled to perform the first manufacturing operation; and a first observer profile associated with a first observer overseeing the first manufacturing operation.

Generally, the computer system can: access a manufacturing operation schedule from a database at the computer system; identify a target time window (e.g., hourly, daily, weekly) corresponding to operational time periods in the facility; and retrieve a set of manufacturing operations scheduled for the target time window in the manufacturing operation schedule. More specifically, the computer system can: within the target time window in the manufacturing operation schedule, extract a first manufacturing operation scheduled for operation at a target location within the facility; extract an operator profile—corresponding to a first operator within the facility scheduled to perform the first manufacturing operation—from the manufacturing operation schedule; and extract an observer profile—corresponding to a first observer assigned to oversee execution of the first manufacturing operation—from the manufacturing operation schedule. The computer system can then, based on the first manufacturing operation, the operator profile, and the observer profile, generate a delivery trigger—as described below—to deliver a set of materials (e.g., hub device, equipment units) to support the operator performing steps of the manufacturing operation at the target location within the facility.

In one implementation, the operator profile defines: a set of guidance preferences associated with the operator and represents preferences for the operator to receive guidance (e.g., text guidance, visual guidance, audio guidance, augmented reality guidance) to perform steps of the manufacturing operation; and a minimum guidance specification associated with the operator and representing a minimum guidance threshold to which the operator must adhere when performing steps of the manufacturing operation. For example, the minimum guidance specification can correspond to: a video guidance specification linked to a set of video media containing instructions to perform the manufacturing operation; and/or a remote observer specification linked to the observer profile in order to enable a remote observer to oversee, such as in real time, the operator performing the manufacturing operation within the facility.

Therefore, the computer system can: generate a delivery trigger for a guidance equipment (e.g., hub device, augmented reality headset) based on the minimum guidance specification defined in the operator profile; assign the delivery trigger to an autonomous cart located within the facility; and trigger the autonomous cart to maneuver throughout the facility in order to deliver the guidance equipment proximal the target location where the operator is assigned to perform the manufacturing operation.

Additionally or alternatively, the computer system can: receive a paper document representing a manufacturing operation schedule for a target time window within the facility; scan the paper document (e.g., at a scanner unit) to extract a set of features from the paper document; and implement computer vision techniques to identify the manufacturing operation, the operator profile, and the observer profile, specified in the paper document.

Accordingly, the computer system can repeat the steps and processes above to generate a set of delivery triggers assigned to a fleet of autonomous carts within the facility to simultaneously support a group of operators performing manufacturing operations within the facility during a target time window.

### 9.4 Delivery Triggers

Blocks of the method S100 recite generating a delivery trigger for a set of mobile devices based on the first operator profile in Block S104. Generally, the computer system can: assign a delivery location within the facility for the set of mobile devices loaded on the autonomous cart; and assign a delivery trigger for the set of mobile devices loaded on the autonomous cart. In particular, the computer system can: extract a scheduled location for performance of the procedure from the digital procedure; extract an operator profile associated with an operator assigned to perform the digital procedure within the facility and indicating a particular degree of guidance for the operator; assign the delivery location for the set of mobile devices based on the scheduled location for performance of the digital procedure; and assign the delivery trigger for the set of mobile devices based on the particular degree of guidance in the operator profile.

In one implementation, the computer system can: extract an operator profile associated with the operator and indicating a first degree of guidance specifying the operator requires observation from an assigned observer during performance of the digital procedure; and, in response to identifying the first degree of guidance for the operator in the operator profile, assign the delivery trigger based on a scheduled time for performance of the digital procedure. For example, the delivery trigger can be set at a target time prior to the scheduled performance of the digital procedure, such as 10 minutes, 30 minutes, 1 hour, prior to performance of the digital procedure by the operator. The computer system can then transmit this delivery trigger and this delivery location to an autonomous cart containing the set of mobile devices.

Thus, at the target time, the autonomous cart can: autonomously maneuver to the delivery location proximal the operator scheduled to perform the digital procedure; in response the achieving a target offset distance between the autonomous cart and the operator, generate a prompt requesting the operator to input operator credentials to the autonomous cart; and serve this prompt to the operator, such as via an integrated interface at the autonomous cart. The autonomous cart can then: receive user credentials from the operator; and, responsive to separation of a mobile device from the autonomous cart, assign the mobile device to the operator.

Therefore, the autonomous cart can autonomously deliver mobile devices to the operator within the facility—required to be observed during performance of the digital procedure—at a target time prior to scheduled performance of the digital procedure, thereby eliminating the need for this operator to move from their scheduled location to retrieve a mobile device.

### 9.4.1 Ad-Hoc Delivery Triggers

In one implementation, the computer system can: extract an operator profile associated with the operator and indicating a second degree of guidance, less than the first degree of guidance, specifying the operator can perform the digital procedure without an assigned observer; and, in response to identifying the second degree of guidance for the operator in the operator profile, assign an ad-hoc (or “as needed”) delivery trigger for the set of mobile devices based on the second degree of guidance.

In one example, the computer system can: receive a request for additional guidance from an operator performing the digital procedure within the facility; in response to receiving the request for additional guidance, generate a prompt to deliver a set of mobile devices to the operator within the facility; and transmit this prompt to an autonomous cart containing the set of mobile devices.

In this example, the autonomous cart can then: autonomously maneuver to the operator performing the digital procedure within the facility; in response the achieving a target offset distance between the autonomous cart and the operator, generate a prompt requesting the operator to input operator credentials to the autonomous cart; and serve this prompt to the operator, such as via an integrated interface at the autonomous cart. The autonomous cart can then: receive user credentials from the operator; responsive to separation of a mobile device from the autonomous cart, assign the mobile device to the operator; and route a video feed captured by mobile device to an observer for overseeing performance of the procedure.

In another example, the computer system can: track time durations for performance of the digital procedure by the operator; in response to a current time duration for performing the digital procedure by the operator exceeding a target time period specified in the digital procedure, generate a prompt to deliver the set of mobile devices to the operator; and transmit this prompt to an autonomous cart containing the set of mobile devices.

In yet another example, as described in U.S. Non-Provisional patent application Ser. No. 17/968,677, filed on 18 Oct. 2022, which is hereby incorporated in its entirety by this reference, the computer system can: interpret a step-deviation during performance of the digital procedure; in response to detecting the step-deviation, generate a prompt to deliver the set of mobile devices to the operator; and transmit this prompt to an autonomous cart containing the set of mobile devices.

Therefore, the autonomous cart can autonomously deliver the set of mobile devices to the operator requiring additional guidance during performance of the digital procedure, thereby eliminating the need for this operator to: maintain a constant video feed with observers; and leave their designated location in order to receive additional guidance for performance of the digital procedure.

### 9.4.2 Event Delivery Triggers: Alarms

In another implementation, the computer system can receive a trigger notification from an equipment in alarm. This alarm can provide a signal or sensor notification if integrated with the computer system or a sensing device such as a microphone can register an audio alarm and/or a visual sensing device can register the flashing red screen on the equipment display device indicating that the equipment is in alarm to the computer system. When a piece of equipment is in alarm this can set off a trigger to dispatch an autonomous cart to the location in the facility where the equipment in alarm is located.

When the computer system executes the dispatch orders an autonomous cart is sent to be loaded with the configuration by the robotic loading system. The autonomous cart is loaded with the smart kiosk configuration containing the required mobile devices and supplies to potentially fix the primary issues that could be affecting that equipment type. The autonomous cart with the smart kiosk configuration is sent to autonomously drive to the location where the equipment is in alarm to meet the operators attempting to determine why the equipment is in alarm and how to correct it. The operator or operators in proximity to the equipment can retrieve a deployed mobile device on the smart kiosk on the autonomous cart, log into the mobile device, receive instructions on the mobile device on how to operate the equipment and how to troubleshoot the equipment to take it out of alarm. In some instances, the computer system can provide a list or include on standby Subject Matter Experts (SMEs) with knowledge on how to utilize, navigate, program, or fix the equipment in alarm. This list of SMEs can be queued up on the mobile device when the operator logs into the computer system. This will help expedite the process and lower the barriers for fixing issues as they come up and prevent errors while executing a process due to not knowing how to get a system out of alarm, saving both time and money for the organization.

### 9.4.2 Event Delivery Triggers

In another implementation, the computer system can receive a trigger from an operator that has been auto-logged out of their mobile device due to an inactivity time-out. The auto-logout can be a tool to enforce security requirements within a facility, but it can make the process of signing back into a mobile device more difficult. Especially in instances where a username and password need to be entered to log into a device if other forms of personal identifiers are not able to be used due to privacy policy concerns. In this case when an operator is signed out of a mobile device, they can summon a nearby autonomous cart with the smart kiosk configuration to come to their location for a quick login into the mobile device where the operator is logged out from. In this instance the smart kiosk on the autonomous cart is used to sign into and then log into the mobile device with minimal effort or time lost by the operator.

In another implementation, the autonomous cart with the smart kiosk configuration is summoned by an operator for the delivery of accessories, such as spare batteries, safety equipment, or accessory cameras. In the case of a mobile device battery being close to depleted the autonomous cart with the smart kiosk can deliver a fully charged mobile device, where the operator can log into, and where the computer system can setup the new mobile device to allow the operator the ability to pick-up exactly where they left off in the execution of a procedure, a live video-teleconference with one or more other people, or the execution in some other application.

### 9.4.4 Generating Delivery Triggers

In one implementation, the computer system can: as described above, extract a set of operator guidance preferences from the operator profile associated with an operator assigned to perform the manufacturing operation within the facility; and identify a remote observer guidance specification in the operator profile representing a preference to link a remote observer to the operator during execution of the manufacturing operation. The computer system can then: extract an object manifest representing verified objects associated with performance of the manufacturing operation from the manufacturing operation schedule; and generate the delivery trigger based on the remote observer guidance specification in the operator profile and the object manifest.

For example, the computer system can: identify a hub device connected to a set of mobile devices (e.g., augmented reality headsets) in the object manifest; and, according to the observer profile, link the hub device to an observer portal associated with the observer assigned to oversee execution of the manufacturing operation within the facility. Therefore, the computer system can: assign the delivery trigger to an autonomous cart within the facility containing the hub device; and trigger an autonomous cart to deliver the hub device proximal the operator executing the manufacturing operation at the target location. The operator can then, prior to initializing the manufacturing operation, retrieve a mobile device from the hub device arranged on the autonomous cart to enable the remote observer to access a live video feed from the mobile device depicting the operator performing the manufacturing operation.

In another implementation, the computer system can: identify a target time window (e.g., between 11:00 AM and 2:00 PM) corresponding to a manufacturing operation at a target location within the facility specified in the manufacturing operation schedule; assign a delivery location for the hub device proximal the target location in the facility; and assign a delivery time (e.g., 10:30 AM) for the autonomous cart prior to the target time window in the manufacturing operation schedule. Accordingly, the computer system can: at the delivery time, trigger the autonomous cart to maneuver the hub device to the delivery location in preparation for the operator scheduled to perform the manufacturing operation; and, at the autonomous cart, initiate scan cycles to detect the delivery trigger at the target location to then deliver the hub device to the operator performing the manufacturing operation. Therefore, the computer system can: trigger an autonomous cart—containing a set of materials (e.g., guidance equipment, equipment units)—to maneuver proximal the target location prior to a scheduled time window for the manufacturing operation; and, at the schedule window, trigger the autonomous cart to deliver the set of materials to the operator, thereby enabling the operator to perform the manufacturing operation.

In yet another implementation, the computer system can: extract an object manifest representing verified objects associated with performance of the manufacturing operation from the manufacturing operation schedule; and identify an object, in the object manifest, corresponding to a degree of risk exceeding a threshold degree of risk exposed to the operator during performance of the manufacturing operation. Accordingly, the computer system can: generate the delivery trigger based on the operator profile and the object identified in the object manifest; and link the observer profile associated with the observer to the delivery trigger.

For example, the computer system can: identify an object in the object manifest corresponding to a potential incendiary event during execution of the manufacturing operation by the operator; and link the object corresponding to the potential incendiary event to the delivery trigger for the manufacturing operation; and link the observer profile to the delivery trigger to enable the observer to oversee (e.g., in real time) the operator performing the manufacturing operation. Therefore, the computer system enables a remote observer to view the operator at the target location during execution of the manufacturing operation, thereby mitigating risk exposure to the operator during performance of the manufacturing operation by the operator.

In yet another implementation, the computer system can: access operator guidance preferences (e.g., text guidance, video guidance, observer guidance) for performing the manufacturing operation; access a process risk (incendiary risk, contagion risk) associated with execution of the manufacturing operation within the facility; and generate the delivery trigger for the autonomous cart based on the operator preferences and the process risk specified for the first manufacturing operation. More specifically, the process risk specified for the manufacturing operation can supersede the operator guidance preferences specified in the operator profile.

For example, the computer system can: access operator guidance preferences corresponding to a first degree of guidance (e.g., text guidance) for performing the manufacturing operation; and identify a process risk corresponding to a second degree of guidance (e.g., a potential contagion event) in handling materials associated with the manufacturing operation. In this example, in response to the second degree of guidance exceeding the first degree of guidance, the computer system can: generate the delivery trigger according to the second degree of guidance specified for the process risk of the manufacturing operation; and link the observer profile to the delivery trigger to enable the observer to oversee execution of the manufacturing operation by the operator.

Therefore, the computer system can: generate a delivery trigger for a set of materials (e.g., guidance materials) based on operator profiles and process risks assigned to scheduled manufacturing operations within the facility; and trigger an autonomous cart to deliver the set of materials to the operator prior to the scheduled time window for performing the manufacturing operation, thereby mitigating risk exposure to the operator during execution of steps for the manufacturing operation.

### 9.5 Robotic Loading System

Blocks of the method S100 recites assigning the delivery trigger to a hub device connected to the set of mobile devices and arranged on an autonomous cart within the facility in Block S106; and triggering the autonomous cart to maneuver the hub device proximal the target location within the facility in Block S108. Generally, a robotic loading system includes a robotic arm mounted at a loading area within the facility and a controller configured to: receive a loading instruction, such as from the computer system, from the autonomous cart, and/or from an operator interfacing with an interactive display of the robotic loading system; retrieve materials from a set of materials stored at the loading area and specified in the loading instruction; and autonomously load these materials onto an autonomous cart proximal the robotic arm, such as by retrieving a tray from a set of trays containing the materials.

In one implementation, the autonomous cart can: autonomously navigate to the loading area within the facility; and couple a charging station (e.g., inductive charging station, charging connector) at a particular loading location within the loading area to receive materials. In this implementation, the robotic loading system can then: receive a cart loading instruction—generated by the computer system—specifying the first set of mobile devices; query a manifest of materials at the loading area for the first set of mobile devices; in response to identifying the first set of mobile devices, in the manifest of materials, retrieve the first set of mobile devices via the robotic arm; and connect (e.g., wirelessly connecting, directly connecting) the first set of mobile devices to the autonomous cart.

The mobile devices and/or accessories can be selected for loading by the robotic loading system onto the mobile hub based on the procedure requirements, the facility requirements, the safety requirements, and the operator preferences. A variety of mobile devices can be in inventory to be selected for loading onto the autonomous cart with the smart kiosk including but not limited to an Augmented Reality headset, a Virtual Reality headset, a Mixed Reality headset, a Holographic headset, an explosion proof rated headset, a sterilizable headset, a tablet device, a mobile phone device, a wearable watch device, a wearable device, or other mobile device type. This can include the procedure being executed requiring a high-end, holographic video display to understand the complexity of the parts to be assembled during the process. In other examples a basic, industrial headset can be required for HD streaming video and noise-canceling in a loud environment. In other instances, the facility can require that the mobile device meet certain standards for chemical compatibility, fit with certain operator personal protective equipment (PPE), or require a certification for operating within an area, such being ATEX Zone 1 or IECEX Class 1, Division 1 certified for operating in areas with explosive atmospheres. In other instances, the mobile devices requires the inclusion of accessories for it to be utilized for safety purposes, such as utilizing a hard hat accessory and clips to connect to a mobile device when operating in an active construction area. In some instances where the procedure content is available in multiple formats it can be up to the operator's preferences on the device with which they are more comfortable using and that provides the information in a format that they prefer, such as using a Virtual Reality device to initiate a refresher training session prior to executing the actual operation of the procedure.

In one implementation, as described above, the computer system can: extract an object manifest representing verified objects associated with performance of the manufacturing operation from the manufacturing operation schedule; and generate the delivery trigger based on the operator profile assigned to the manufacturing operation and the object manifest. In this implementation, the computer system can then: link the delivery trigger to an autonomous cart within the facility, such as by selecting an autonomous cart from a fleet of autonomous carts assigned to the facility; and trigger an autonomous cart within the facility to maneuver proximal the loading system within the facility. Accordingly, the loading system can then: query a set of trays for a target tray containing the verified objects associated with the manufacturing operation; trigger a robotic arm to retrieve the target tray from the set of trays; and maneuver the robotic arm to locate the target tray onto the autonomous cart. Additionally, the loading system can then: trigger the robotic arm to load the hub device connected to the set of mobile devices associated with the delivery trigger; and maneuver the robotic arm to locate the hub device onto the autonomous cart.

Therefore, following loading the target tray and the hub device onto the autonomous cart by the loading system, the computer system can—prior to a scheduled time window specified in the manufacturing operation schedule—trigger the autonomous cart to maneuver the target tray and the hub device proximal the target location assigned to the operator performing the manufacturing operation.

### 9.6 Detecting Delivery Triggers

Blocks of the method S100 recite, in response to detecting the delivery trigger, maintaining the autonomous cart at a target offset distance from the first operator performing the first manufacturing operation at the target location in Block S109. Generally, the autonomous cart can: access a live video feed from an optical sensor arranged on the autonomous cart and defining a field of view of the operator performing the manufacturing operation at the target location; extract visual features from the live video feed; and implement computer vision techniques, such as described in U.S. Non-Provisional application Ser. No. 17/968,684, filed on 18 Oct. 2022, which is hereby incorporated in its entirety by this reference, to detect the delivery trigger at the target location based on the visual features.

In one implementation, the autonomous cart can: identify a particular object in the live video feed as corresponding to a target object specified in the delivery trigger for the manufacturing operation based on the set of visual features; and, in response to identifying the particular object as corresponding to the target object, maintain the autonomous cart at the target offset distance from the operator performing the manufacturing operation. Accordingly, the autonomous cart can then: generate a prompt requesting the first operator to input user credentials at the hub device arranged on the autonomous cart; and serve the prompt to an interactive display coupled to the autonomous cart. As described above, the computer system can then: detect removal of a mobile device, in a set of mobile devices, connected to the hub device; and assign the mobile device to the operator according to the set of user credentials received.

Additionally, the computer system can then: access a video feed from the mobile device associated with the operator and defining a field of view of the operator performing the manufacturing operation; and route the video feed to an observer portal associated with the observer assigned to oversee the manufacturing operation according to the operator profile.

As described in U.S. Non-Provisional application Ser. No. 18/120,284, filed on 10 Mar. 2023, which is hereby incorporated in its entirety by this reference, the autonomous cart can: access a live video feed from an optical sensor arranged at the autonomous cart and defining a field of view of the target location; extract a set of visual features from the live video feed; and implement computer vision techniques to interpret a particular offset distance between the operator performing the manufacturing operation at the target location and the autonomous cart arranged proximal the target location. Accordingly, in response to the particular offset distance deviating from a target offset distance, the autonomous cart can: maneuver toward the target offset distance from the operator and maintain this target offset distance during performance of the manufacturing operation; generate the prompt requesting the operator to input user credentials at the hub device arranged on the autonomous cart; and serve the prompt to the interactive display coupled to the autonomous cart.

In another implementation, the computer system can: access a live video feed from an optical sensor arranged proximal the target location and defining a field of view of the operator performing the manufacturing operation; extract visual features from the live video feed; and implement computer vision techniques, such as described in U.S. Non-Provisional application Ser. No. 17/968,684, filed on 18 Oct. 2022, which is hereby incorporated in its entirety by this reference, to detect the delivery trigger at the target location based on the visual features. In this implementation, in response to detecting the delivery trigger, the computer system can: trigger the autonomous cart to maintain a target offset distance from the operator at the target location; generate the prompt requesting the operator to input user credentials at the hub device arranged on the autonomous cart; and serve the prompt to the interactive display coupled to the autonomous cart.

In yet another implementation, the computer system can: access a target image depicting a field of view of the operator performing the manufacturing operation from an operator device (e.g., tablet, scanner) associated with the operator; extract visual features from the target image; and implement computer vision techniques, such as described in U.S. Non-Provisional application Ser. No. 17/968,684, filed on 18 Oct. 2022, which is hereby incorporated in its entirety by this reference, to detect the delivery trigger at the target location based on the visual features.

### 9.6.1 Operator Device

In one implementation, the computer system can: detect initializing of the manufacturing operation by the operator at the target location within the facility; and, in response to detecting initializing of the manufacturing operation, trigger the autonomous cart to maneuver the hub device proximal the target location within the facility. More specifically, in this implementation, an operator device (e.g., tablet) associated with the operator can: access a set of instructional blocks corresponding to steps for performing the manufacturing operation from the computer system; and receive initialization of a first instructional block, in the set of instructional blocks, from the operator at the operator device.

Accordingly, in response to receiving initialization of the first instructional block by the operator, the operator device can: extract a first instruction in a first format (e.g., text format) corresponding to a first degree of guidance from the first instructional block; and serve the first instruction in the first instructional block to the operator device. Additionally, in response to receiving initialization of the first instructional block by the operator, the computer system can then trigger the autonomous cart to maneuver the hub device proximal the target location within the facility.

Additionally, the operator can: receive selection of a second degree of guidance corresponding to remote observation guidance for the first instruction at the first operator device; and, in response to receiving selection of the second degree of guidance, maintain the autonomous cart at the target offset distance from the first operator performing the first manufacturing operation. Thus, as described above, the autonomous cart can then: generate a prompt requesting the first operator to input user credentials at the hub device arranged on the autonomous cart; and serve the prompt at an interactive display coupled to the autonomous cart.

### 9.6.2 Risk Events

As described in U.S. Non-Provisional application Ser. No. 17/968,684, filed on 18 Oct. 2022, which is hereby incorporated in its entirety by this reference, the autonomous cart can: access a live video feed from an optical sensor arranged at the autonomous cart and defining a field of view at the target location; extract a set of visual features from the live video feed; and implement computer vision techniques to interpret a risk event at the target location during performance of the manufacturing operation by the operator.

Accordingly, in response to detecting a risk event at the target location based on the set of visual features, the autonomous cart can: access a target offset distance between the autonomous cart and the first operator associated with the risk event; generate a prompt notifying the first operator to pause performance of the first manufacturing operation and input user credentials to retrieve the first mobile device from the autonomous cart; maneuver the autonomous cart to maintain the target offset distance between the first operator and the autonomous cart; and serve the prompt at a display coupled to the autonomous cart. Thus, the autonomous cart can enable the operator to connect to a remote observer in response to a risk event during performance of the manufacturing operation, thereby mitigating risk exposure to the operator and enabling the operator to continue execution of the manufacturing operation.

### 9.7 Deploying Autonomous Cart

In one implementation, in response to detecting the delivery trigger, the computer system can: query a list of autonomous carts stationed at the loading area within the facility; in response to identifying an autonomous cart, in the list of autonomous carts, containing the set of mobile devices, generate a prompt to deliver the set of mobile devices to the operator; and serve this prompt to the autonomous cart.

Alternatively, in this implementation, the computer system can: in response to identifying absence of an autonomous cart containing the set of mobile devices, in the list of autonomous carts, generate a loading prompt to load an autonomous cart at the loading station with the set of mobile devices; and serve this loading prompt to the robotic loading system for autonomous loading of the set of mobile devices.

In another implementation, in response to detecting the delivery trigger, the computer system can: query a list of autonomous carts proximal (e.g., 10 meter radius, 20 meter radius) the operator performing the digital procedure; in response to identifying an autonomous cart, in the list of autonomous carts, containing the set of mobile devices, generate a prompt to autonomously maneuver this autonomous cart to the operator; and serve this prompt to the autonomous cart.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for remotely observing a manufacturing operation in a facility comprising:
accessing a manufacturing operation schedule defining a first manufacturing operation corresponding to a first operator at a target location within the facility;
during a first time period:
at a hub device, receiving a first set of user credentials associated with the first operator, the hub device connected to a first mobile device; and
in response to separation of the first mobile device from the hub device, associating the first mobile device with the first operator according to the first set of user credentials; and
during a second time period:
accessing a first set of observer credentials representing a first observer overseeing performance of the first manufacturing operation;
in response to the first operator initializing the first manufacturing operation, accessing a first video feed from the first mobile device; and
serving the first video feed from the first mobile device to a first observer portal associated with the first observer based on the first set of observer credentials.

2. The method of claim 1 wherein accessing the first video feed from the first mobile device comprises:
in response to coupling of the first mobile device to the hub device, uploading the first video feed from the first mobile device to the hub device;
extracting a first set of visual features from the first video feed;
identifying a first manufacturing operation in the first video feed associated with the first observer based on the first set of visual features; and
in response to identifying the first manufacturing operation, transmitting the first video feed from the hub device to the first observer based on the first set of observer credentials and the first manufacturing operation.

3. The method of claim 1, further comprising:
during an intermediate time period following the first time period:
at the hub device, receiving a second set of user credentials associated with a second operator, the hub device connected to a second mobile device; and
in response to separation of the second mobile device from the hub device, associating the second mobile device with the second operator according to the second set of user credentials; and
during the second time period:
accessing a second video feed depicting the second operator from the second mobile device;
synchronizing the first video feed and the second video feed; and
transmitting a split-screen video feed to the first observer based on:
the first set of observer credentials;
a first device identifier associated with the first device; and
a second device identifier associated with the second mobile device.

4. The method of claim 1:
wherein accessing the first set of observer credentials comprises accessing the first set of observer credentials defining a first set of viewable regions of the facility; and
wherein serving the first video feed from the first mobile device to the first observer portal comprises:
scanning a first frame in the first video feed for a first set of visual features;
identifying a first set of restricted regions of the facility depicted in the first frame based on the first set of viewable regions for the first observer;
obscuring the first set of restricted regions in a first modified video feed; and
transmitting the first modified video feed to the first observer portal associated with the first observer.

5. The method of claim 1:
further comprising, in response to the first operator initializing the first manufacturing operation:
accessing a second video feed from a second device defining a field of view of the target location in the facility, the second video feed concurrent with the first video feed and depicting the first operator and the first mobile device;
extracting a set of visual features from the second video feed;
interpreting a first series of locations of the first mobile device in the facility based on the set of visual features;
identifying a set of restricted regions depicted in the first video feed based on the first series of locations of the first mobile device; and
obscuring the first set of restricted regions in a first modified video feed; and
wherein serving the first video feed from the first mobile device to the first observer portal comprises serving the first modified video feed comprising the first set of restricted regions to the first observer portal associated with the first observer.

6. The method of claim 1:
wherein accessing the manufacturing operation schedule comprises accessing the manufacturing operation schedule defining an operator profile associated with the first operator representing guidance preferences for performing the first manufacturing operation; and
further comprising, during an initial time period preceding the first time period:
identifying a remote observer guidance specification in the operator profile; and
in response to identifying the remote observer guidance specification, triggering an autonomous cart to maneuver the hub device proximal the target location within the facility.

7. The method of claim 6, further comprising during the initial time period:
accessing a live video feed from an optical sensor arranged at the autonomous cart and defining a field of view of the target location within the facility;
extracting a set of visual features from the live video feed;
detecting the first operator at a first offset distance from the autonomous cart based on the set of visual features; and
in response to the first offset distance deviating from a target offset distance:
triggering the autonomous cart to maintain the target offset distance from the first operator at the target location;
generating a prompt requesting the first operator to input user credentials at the hub device arranged on the autonomous cart;
serving the prompt at an interactive display coupled to the autonomous cart; and
in response to receiving the first set of user credentials:
interpreting authorization for removal of the first mobile device by the operator based on the first set of user credentials; and
triggering a locking mechanism at the hub device to release the first mobile device from the hub device.

8. The method of claim 1:
wherein accessing the manufacturing operation schedule comprises accessing the manufacturing operation schedule defining a first scheduled time window for the first operator to perform the first manufacturing operation; and
further comprising:
generating a first delivery trigger for the hub device defining:
an initial time prior to the first scheduled time window; and
the target location within the facility;
assigning the first delivery trigger for the hub device to the first manufacturing operation in the manufacturing operation schedule; and
in response to detecting the first delivery trigger at the initial time, triggering an autonomous cart to maneuver the hub device proximal the target location within the facility.

9. The method of claim 1:
wherein accessing the manufacturing operation schedule comprises accessing the manufacturing operation schedule defining a first delivery trigger for the hub device arranged at an autonomous cart within the facility; and
further comprising, during an initial time period preceding the first time period:
accessing a live video feed from an optical sensor arranged on the autonomous cart and defining a field of view of the target location;
extracting a set of visual features from the live video feed;
detecting the first delivery trigger associated with the first manufacturing operation based on the set of visual features in the live video feed; and
in response to detecting the first delivery trigger, triggering the autonomous cart to maintain a target offset distance from the first operator at the target location within the facility.

10. A method for remotely observing a manufacturing operation in a facility comprising:
accessing a manufacturing operation schedule defining:
a first manufacturing operation corresponding to a first operator at a target location within the facility;
a first operator profile representing guidance preferences for the first operator scheduled to perform the first manufacturing operation; and
a first observer profile associated with a first observer overseeing the first manufacturing operation;
generating a delivery trigger for a set of mobile devices based on the first operator profile;
assigning the delivery trigger to a hub device connected to the set of mobile devices and arranged on an autonomous cart within the facility;
triggering the autonomous cart to maneuver the hub device proximal the target location within the facility;
in response to detecting the delivery trigger, maintaining the autonomous cart at a target offset distance from the first operator performing the first manufacturing operation at the target location;
receiving a first set of user credentials associated with the first operator at the hub device arranged on the autonomous cart; and
in response to separation of the first mobile device from the hub device:
associating a first mobile device, in the set of mobile devices, with the first operator according to the first set of user credentials; and
serving a first video feed from the first mobile device to a first observer portal associated with the first observer based on the first observer profile.

11. The method of claim 1:
wherein generating the delivery trigger comprises:
identifying a remote observer guidance specification in the operator profile corresponding to the first operator;
accessing a first object manifest representing verified objects associated with performance of the first manufacturing operation;
generating the delivery trigger based on the remote observer guidance specification and the first object manifest; and
linking the first observer profile to the delivery trigger; and
wherein detecting the delivery trigger comprises:
accessing a first live video feed from a first optical sensor defining a first field of a workspace proximal the first operator at the target location;
extracting a first set of visual features from the first live video feed;
detecting the delivery trigger by interpreting a first object, in the first object manifest, in the first live video feed based on the first set of visual features; and
in response to interpreting the first object, maintaining the autonomous cart at the target offset distance to the first operator performing the first manufacturing operation.

12. The method of claim 10, wherein maintaining the autonomous cart at the target offset distance comprises:
accessing a second live video feed from a second a second optical sensor arranged at the autonomous cart and defining a second field of view of the target location;
extracting a second set of visual features from the second live video feed;
interpreting a first offset distance between the autonomous cart and the first operator depicted in the second live video feed based on the second set of visual features;
in response to the first offset distance deviating from the target offset distance, triggering the autonomous cart to maneuver toward the target offset distance from the operator; and
in response to the autonomous cart occupying the target offset distance from the first operator:
generating a prompt requesting the first operator to input user credentials at the hub device arranged on the autonomous cart; and
serving the prompt at an interactive display coupled to the autonomous cart.

13. The method of claim 10:
wherein accessing the manufacturing operation schedule further comprises accessing the manufacturing operation schedule defining a first scheduled time window for the first operator to perform the first manufacturing operation;
wherein assigning the delivery trigger to the hub device comprises:
assigning a delivery location to the hub device proximal the target location within the facility; and
assigning an initial time prior to the first scheduled time window;
wherein triggering the autonomous cart to maneuver the hub device comprises, at the initial time, triggering the autonomous cart to maneuver the hub device to the delivery location within the facility; and
wherein detecting the delivery trigger comprises detecting the delivery trigger at the target location by:
accessing a live video feed from an optical sensor arranged at the autonomous cart and defining a field of view at the target location;
extracting a set of visual features from the live video feed; and
in response to detecting the delivery trigger in the live video feed based on the set of visual features, maintaining the autonomous cart at the target offset distance form the first operator performing the first manufacturing operation at the target location.

14. The method of claim 10:
wherein generating the delivery trigger comprises:
accessing a first object manifest representing verified objects associated with performance of the first manufacturing operation;
identifying a first object, in the first object manifest, as corresponding to a degree of risk exceeding a threshold degree of risk exposed to the first operator during performance of the first manufacturing operation;
generating the delivery trigger based on the operator profile and the first object; and
linking the first observer profile to the delivery trigger; and
wherein detecting the delivery trigger comprises:
accessing a live video feed from an optical sensor arranged at the autonomous cart and defining a field of view at the target location;
extracting a set of visual features from the live video feed; and
in response to detecting the first object in the live video feed based on the set of visual features, maintaining the autonomous cart at the target offset distance from the first operator performing the first manufacturing operation at the target location.

15. The method of claim 10:
wherein triggering the autonomous cart to maneuver the hub device comprises:
at a first operator device associated with the first operator, accessing a first set of instructional blocks corresponding to the first manufacturing operation;
in response to the first operator initializing a first instructional block, in the first set of instructional blocks, at the first operator device:
extracting a first instruction in a text format corresponding to a first degree of guidance from the first instructional block;
triggering the autonomous cart to maneuver the hub device proximal the target location at the facility; and
serving the first instruction at the first operator device; and
wherein detecting the delivery trigger comprises:
receiving selection of a second degree of guidance corresponding to remote observation guidance for the first instruction at the first operator device;
in response to receiving selection of the second degree of guidance, maintaining the autonomous cart at the target offset distance from the first operator performing the first manufacturing operation;
generating a prompt requesting the first operator to input user credentials at the hub device arranged on the autonomous cart; and
serving the prompt at an interactive display coupled to the autonomous cart.

16. The method of claim 10:
wherein generating the delivery trigger comprises:
accessing a first object manifest representing verified objects associated with performance of the first manufacturing operation; and
generating the delivery trigger based on the operator profile and the first object manifest;
wherein assigning the first delivery trigger to the hub device comprises:
triggering the autonomous cart to maneuver proximal a robotic arm arranged at a loading system;
linking the delivery trigger to the autonomous cart at the loading system; and
at the loading system:
triggering the robotic arm to retrieve a first tray, in a set of trays, containing a first set of objects corresponding to the first object manifest;
maneuvering the robotic arm to locate the first tray at the autonomous cart;
triggering the robotic arm to retrieve the hub device connected to the set of mobile devices associated with the delivery trigger; and
maneuvering the robotic arm to locate the hub device at the autonomous cart; and
wherein triggering the autonomous cart to maneuver the hub device comprises, in response to initializing the first manufacturing operation by the first operator, maneuvering the autonomous cart from the loading system to the target location within the facility.

17. The method of claim 10, wherein generating the delivery trigger comprises:
extracting a first degree of guidance for performing the first manufacturing operation from the first operator profile;
correlating the first manufacturing operation with a second degree of guidance representing a first process risk associated with execution of the first manufacturing operation;
in response to the second degree of guidance exceeding the first degree of guidance, generating the delivery trigger based on the second degree of guidance for the first manufacturing operation; and
linking the first observer profile to the delivery trigger.

18. The method of claim 10, wherein detecting the delivery trigger comprises, during a scan cycle at the autonomous cart:
accessing a live video feed from an optical sensor arranged at the autonomous cart and defining a field of view at the target location;
extracting a set of visual features from the live video feed; and
in response to detecting a risk event at the target location based on the set of visual features:
accessing a target offset distance between the autonomous cart and the first operator associated with the risk event;
generating a prompt notifying the first operator to pause performance of the first manufacturing operation and input user credentials to retrieve the first mobile device from the autonomous cart;
maneuvering the autonomous cart to maintain the target offset distance between the first operator and the autonomous cart; and
serving the prompt at a display coupled to the autonomous cart.

19. The computer system of claim 1, wherein serving the first video feed from the first mobile device comprises:
in response to coupling of the first mobile device to the hub device, uploading the first video feed from the first mobile device to the hub device;
extracting a first set of visual features from the first video feed;
identifying a first manufacturing operation in the first video feed associated with the first observer based on the first set of visual features; and
in response to identifying the first manufacturing operation, transmitting the first video feed from the hub device to the first observer based on the first set of observer credentials and the first manufacturing operation.

20. A method for remotely observing a manufacturing operation in a facility comprising:
accessing a manufacturing operation schedule defining:
a first manufacturing operation corresponding to a first operator at a target location within the facility; and
a first operator profile representing guidance preferences for the first operator scheduled to perform the first manufacturing operation;
generating a delivery trigger for a set of mobile devices based on the first operator profile;
assigning the delivery trigger to a hub device connected to the set of mobile devices and arranged on an autonomous cart within the facility;
triggering the autonomous cart to maneuver the hub device proximal the target location within the facility; and
in response to detecting the delivery trigger:
receiving a first set of user credentials associated with the first operator at the hub device arranged on the autonomous cart;
associating a first mobile device, in the set of mobile devices, with the first operator according to the first set of user credentials; and
serving a first video feed from the first mobile device to a first observer portal associated with a first observer.
